(19) United States
(12) Patent Application Publication
(10) Pub. No.: US 2026/0226371 A1
(43) Pub. Date: Aug. 6, 2026

(54) COMPOSITIONS, SYSTEMS, AND METHODS FOR TREATING A SUBSTRATE

(71) Applicant: PPG Industries Ohio, Inc., Cleveland, OH (US)

(72) Inventors: Lyanne Valdez, Pittsburgh, PA (US); Tanvi Siraj Ratani, Pittsburgh, PA (US); Corey James DeDomenic, Trafford, PA (US); Mark William McMillen, Cabot, PA (US); Scott Joseph Moravek, Mars, PA (US); Reza Michael Rock, Pittsburgh, PA (US)

(73) Assignee: PPG Industries Ohio, Inc., Cleveland, OH (US)

(21) Appl. No.: 19/152,999

(22) PCT Filed: Feb. 1, 2024
(86) PCT No.: PCT/US2024/013974

§ 371 Date: Aug. 1, 2025

Related U.S. Application Data
(60) Provisional application No. 63/482,779, filed on Feb. 1, 2023.

(51) Int. Cl. C11D 3/12; C09D 7/40; C11D 3/36; C23C 22/34; C25D 13/20; C25D 13/22

(52) U.S. Cl. CPC C11D 3/1206; C09D 7/70; C11D 3/361; C23C 22/34; C25D 13/20; C25D 13/22

(57) ABSTRACT

The present disclosure is directed to cleaner-coater compositions comprising a Group IVB metal in an amount of 50 ppm to 8,000 ppm based on total weight of the cleaner-coater composition; an electropositive metal; a builder comprising a phosphonate and/or a sugar alcohol; and a cleaner-coater surfactant in an amount of 50 ppm to 20,000 ppm based on total weight of the cleaner-coater composition. The present disclosure is also directed to systems and methods for treating a substrate comprising any of the cleaner-coater compositions disclosed herein and an electrodepositable coating composition. The present disclosure is also directed to substrates treated by any of the cleaner-coater compositions, systems, and/or methods disclosed herein.

### FIELD

The present disclosure relates to compositions, systems, and methods for treating a substrate.

### BACKGROUND

The use of protective coatings on metal substrates for improved corrosion resistance and paint adhesion is common. Typically, a substrate surface is treated by sequentially applying (1) a cleaning composition, (2) a pretreatment composition, and (3) an electrodepositable coating composition.

### SUMMARY

Disclosed herein is a cleaner-coater composition comprising a Group IVB metal in an amount of 50 ppm to 8,000 ppm based on total weight of the cleaner-coater composition, an electropositive metal, a builder comprising a phosphonate and/or a sugar alcohol, and a cleaner-coater surfactant in an amount of 50 ppm to 20,000 ppm based on total weight of the cleaner-coater composition.

The present disclosure is further directed to a system for treating a substrate comprising (a) any of the cleaner-coater compositions disclosed herein for treating at least a portion of a surface of the substrate; and (b) any of the electrodepositable coating compositions disclosed herein for coating at least in part the portion of the surface of the substrate treated with the cleaner-coater composition.

The present disclosure is further directed to a system for treating a substrate comprising a cleaner-coater composition comprising a Group IVB metal in an amount of 50 ppm to 8,000 ppm based on total weight of the cleaner-coater composition, an electropositive metal such as copper, and a surfactant in an amount of 50 ppm to 20,000 ppm based on total weight of the cleaner-coater composition for treating at least a portion of a surface of the substrate; and an electrodepositable coating composition for coating at least in part the portion of the surface of the substrate treated with the cleaner-coater composition.

The present disclosure is further directed to a method for coating a substrate comprising applying any of the cleaner-coater compositions disclosed herein to at least a portion of a surface of the substrate.

The present disclosure is further directed to a method of treating a substrate comprising applying any of the cleaner-coater compositions disclosed herein to at least a portion of a surface of the substrate; and applying any of the electrodepositable coating compositions disclosed herein to at least a portion of the surface of the substrate to which the cleaner-coater composition is applied.

The present disclosure is further directed to a substrate treated with any of the systems disclosed herein.

The present disclosure is further directed to a substrate treated with any of the methods disclosed herein.

### DETAILED DESCRIPTION

For purposes of the following detailed description, it is to be understood that the disclosure may assume various alternative variations and step sequences, except where expressly specified to the contrary. Moreover, other than in any operating examples, or where otherwise indicated, all numbers such as those expressing values, amounts, percentages, ranges, subranges, and fractions may be read as if prefaced by the word “about,” even if the term does not expressly appear. Accordingly, unless indicated to the contrary, the numerical parameters set forth in the following specification and attached claims are approximations that may vary depending upon the desired properties to be obtained by the present disclosure. At the very least, and not as an attempt to limit the application of the doctrine of equivalents to the scope of the claims, each numerical parameter should at least be construed in light of the number of reported significant digits and by applying ordinary rounding techniques. Where a closed or open-ended numerical range is described herein, all numbers, values, amounts, percentages, subranges, and fractions within or encompassed by the numerical range are to be considered as being specifically included in and belonging to the original disclosure of this application as if these numbers, values, amounts, percentages, subranges and fractions had been explicitly written out in their entirety.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard variation found in their respective testing measurements.

As used herein, unless indicated otherwise, a plural term can encompass its singular counterpart and vice versa, unless indicated otherwise. For example, although reference is made herein to “a” Group IVB metal” and “an” electropositive metal, a combination (i.e., a plurality) of these components can be used.

In addition, in this application, the use of “or” means “and/or” unless specifically stated otherwise, even though “and/or” may be explicitly used in certain circumstances.

As used herein, “including,” “containing” and like terms are understood in the context of this application to be synonymous with “comprising” and are therefore open-ended and do not exclude the presence of additional undescribed or unrecited elements, materials, ingredients, or method steps. As used herein “consisting of” is understood in the context of this application to exclude the presence of any unspecified element, ingredient, or method step. As used herein, “consisting essentially of” is understood in the context of this application to include the specified elements, materials, ingredients, or method steps “and those that do not materially affect the basic and novel characteristic(s)” of what is being described. Open-ended terms include closed terms, e.g., “comprising” includes “consisting of” and “consisting essentially of.”

As used herein, the terms “on,” “onto,” “applied on,” “applied onto,” “formed on,” “deposited on,” “deposited onto,” means formed, overlaid, deposited, or provided on but not necessarily in contact with the surface. For example, a composition “applied onto” a substrate does not preclude the presence of one or more other intervening coating layers of the same or different composition located between the composition and the substrate.

As used herein, a “system” refers to a set or kit of compositions for treating a substrate to form a treatment stack on the treated substrate. Recitation of the compositions in a particular order is for convenience only and is not intended to limit the order in which the substrate is treated with the compositions.

As used herein, “treatment stack” refers to a plurality of coatings formed on a substrate surface.

As used herein, “cleaner-coater composition” refers to a composition that is formulated to clean and/or degrease the surface of a substrate to remove grease, dirt, oil, and/or other extraneous matter while also acting as a pretreatment composition.

As used herein, “pretreatment composition” refers to a composition that is capable of reacting with and chemically altering the substrate surface and binding to it to form a coating that affords corrosion protection. The pretreatment composition may be an aqueous composition.

As used herein, “Group IVB metal” refers to an element that is in Group IVB of the CAS version of the Periodic Table of the Elements as is shown, for example, in the Handbook of Chemistry and Physics, 63^{rd} edition (1983), corresponding to Group 4 in the actual IUPAC numbering.

As used herein, “Group IVB metal compound” refers to a compound that includes an element that is in Group IVB of the CAS version of the Periodic Table of the Elements.

As used herein, “surfactant” refers to a molecule that suspends, encapsulates, or emulsifies organic-containing contaminants. A surfactant comprises a hydrophilic portion and a hydrophobic portion that decreases the surface tension between two liquids, a liquid and a gas, or a liquid and a solid.

As used herein, “builder” refers to a compound that is capable of removing metal from the composition through, for example, chelation, ionic interactions, or precipitation. A builder does not have emulsifying properties.

As used herein, “coating composition” refers to a composition, e.g., a solution, mixture, or a dispersion, that is capable of producing a coating on a portion of a substrate. “Coating” as used herein includes films, layers, and the like.

As used herein, “curing agent” refers to any reactive material that can be added to cure a composition. As used herein, the term “cure,” “cured,” or similar terms, means that reactive functional groups of components that form the composition react to form a coating or bond.

As used herein, “salt” refers to an ionic compound made up of metal or non-metal cations and non-metallic anions and having an overall electrical charge of zero. Salts may be hydrated or anhydrous.

As used herein, “aqueous composition” or “aqueous coating composition” refers to a solution or dispersion in a medium that comprises predominately water. For example, the aqueous composition may comprise water in an amount of more than 50 wt. %, or more than 70 wt. %, or more than 80 wt. %, or more than 90 wt. %, or more than 95 wt. % based on the total weight of the composition. That is, the aqueous composition may, for example, consist substantially of water.

As used herein, the term “dispersion” refers to a two-phase transparent, translucent or opaque system in which non-soluble particles are in the dispersed phase and an aqueous medium, which includes water, is in the continuous phase.

As used herein, “non-soluble” means not dissolved in an aqueous medium.

As used herein, “soluble” means dissolved in an aqueous medium.

Ambient conditions generally refer to room temperature (23° C.) and humidity conditions or temperature and humidity conditions that are typically found in the area in which the composition is being applied to a substrate, e.g., at 10° C. to 32° C. and 4% to 80% relative humidity, while slightly thermal conditions are temperatures that are slightly above ambient temperature. As used herein, “slightly thermal conditions” are temperatures that range from greater than 32° C. to 40° C.

As used herein, unless indicated otherwise, “substantially free” means that a particular material is present in a mixture or a composition (or a coating formed therefrom) in an amount of less than 5 parts per million (ppm) based on total weight of the mixture or composition (or a coating formed therefrom). As used herein, unless indicated otherwise, the term “essentially free” means that a particular material is present in a mixture or a composition (or a coating formed therefrom) in an amount of less than 1 ppm based on total weight of the mixture or composition (or a coating formed therefrom). As used herein, unless indicated otherwise, the term “completely free” means that a particular material is present in a mixture or a composition (or a coating formed therefrom) in an amount of less than 1 part per billion (ppb) based on total weight of the mixture or composition (or a coating formed therefrom) or that such material is below the detection limit of common analytical techniques. When a mixture or a composition (or a coating formed therefrom) is substantially free, essentially free, or completely free of a particular material, this means that such material in any form is excluded from the mixture or composition (or a coating formed therefrom), except that such material may unintentionally be present as a result of, for example, carry-over from prior treatment baths in the processing line, contamination from a substrate, or the like.

Unless otherwise disclosed herein, as used herein, the terms “total composition weight,” “total weight of a composition,” or similar terms refer to the total weight of all ingredients being present in the respective composition including any carriers and solvents.

As mentioned above, the present disclosure is directed to a cleaner-coater composition comprising a Group IVB metal in an amount of 50 ppm to 8,000 ppm based on total weight of the cleaner-coater composition; an electropositive metal; a builder comprising a phosphonate and/or a sugar alcohol; and a cleaner-coater surfactant in an amount of 50 ppm to 20,000 ppm based on total weight of the cleaner-coater composition.

As mentioned above, the present disclosure is directed to a cleaner-coater composition comprising a Group IVB metal in an amount of 50 ppm to 8,000 ppm based on total weight of the cleaner-coater composition; an electropositive metal; a builder comprising a phosphonate and/or a sugar alcohol; and a surfactant in an amount of 50 ppm to 20,000 ppm based on total weight of the cleaner-coater composition.

The present disclosure is also directed to a system for treating a substrate comprising any of the cleaner-coater compositions disclosed herein for treating at least a portion of a surface of the substrate; and any of the electrodepositable coating compositions disclosed herein for coating at least in part the portion of the surface of the substrate treated with the cleaner-coater composition.

The present disclosure is also directed to a system for treating a substrate comprising: a cleaner-coater composition comprising a Group IVB metal in an amount of 50 ppm to 8,000 ppm based on total weight of the cleaner-coater composition, an electropositive metal such as copper, and a surfactant in an amount of 50 ppm to 20,000 ppm based on total weight of the cleaner-coater composition for treating at least a portion of a surface of the substrate; and an electrodepositable coating composition comprising an electrodepositable binder comprising an active hydrogen-containing, ionic salt group-containing film-forming polymer, a curing agent, and a plate-like pigment present in a pigment-to-binder ratio of at least 0.4:1.

The present disclosure is also directed to a method for coating a substrate comprising applying any of the cleaner-coater compositions disclosed herein.

The present disclosure is also directed to a method of treating a substrate comprising applying any of the cleaner-coater compositions disclosed herein to at least a portion of a surface of the substrate; and applying any of the electrodepositable coating compositions disclosed herein to at least a portion of the surface of the substrate to which the cleaner-coater composition is applied.

The present disclosure is also directed to a substrate treated by any of the systems disclosed herein.

The present disclosure is also directed to a substrate treated with any of the methods disclosed herein.

### Cleaner-Coater Composition

The cleaner-coater composition may comprise, consist essentially of, or consist of a Group IVB metal, an electropositive metal, a surfactant, and optionally a builder and/or water.

The cleaner-coater composition may comprise a Group IVB metal. The Group IVB metal may comprise zirconium, titanium, hafnium, or combinations thereof. The Group IVB metal may be provided in the form of an acid or a salt. For example, the Group IVB metal may be a compound of zirconium, titanium, hafnium, or a mixture thereof. Suitable compounds of zirconium include, but are not limited to, hexafluorozirconic acid, alkali metal and ammonium salts thereof, zirconium tetrafluoride, ammonium zirconium carbonate, zirconium carboxylates and zirconium hydroxyl carboxylates, such as zirconium acetate, zirconium oxalate, ammonium zirconium glycolate, ammonium zirconium lactate, ammonium zirconium citrate, zirconium basic carbonate, zirconyl nitrate, zirconyl sulfate, oxides or hydroxides of zirconium, and mixtures thereof. Suitable compounds of titanium include, but are not limited to, hexafluorotitanic acid, fluorotitanic acid and salts thereof. A suitable compound of hafnium includes, but is not limited to, hafnium nitrate.

The Group IVB metal may be present in the cleaner-coater composition in an amount of at least 50 ppm based on total weight of the cleaner-coater composition, such as at least 100 ppm, such as at least 150 ppm, such as at least 200 ppm, such as at least 500 ppm, such as at least 600 ppm, such as at least 700 ppm, such as at least 800 ppm, such as at least 900 ppm. The Group IVB metal may be present in the cleaner-coater composition in an amount of no more than 8,000 ppm based on total weight of the cleaner-coater composition, such as no more than 6,000 ppm, such as no more than 5,000 ppm, such as no more than 4,000 ppm, such as no more than 3,000 ppm, such as no more than 2,000 ppm, such as no more than 1,500 ppm. The Group IVB metal may be present in the cleaner-coater composition in an amount of 50 ppm to 8,000 ppm based on total weight of the cleaner-coater composition, such as 100 ppm to 6,000 ppm, such as 150 ppm to 4,000 ppm, such as 200 ppm to 2,000 ppm, such as 500 ppm to 5,000 ppm, such as 500 ppm to 1,500 ppm, such as 600 ppm to 4,000 ppm, such as 700 ppm to 3,000 ppm, such as 800 ppm to 2,000 ppm, such as 900 ppm to 1,500 ppm.

The cleaner-coater composition may also comprise an electropositive metal. As used herein, “electropositive metal” refers to metals that are more electropositive than the metal substrate. This means that, for purposes of the present disclosure, the term “electropositive metal” encompasses metals that are less easily oxidized than the metal of the metal substrate that is being treated. As will be appreciated by those skilled in the art, the tendency of a metal to be oxidized is called the oxidation potential, is expressed in volts, and is measured relative to a standard hydrogen electrode, which is arbitrarily assigned an oxidation potential of zero. The oxidation potential for several elements is set forth in Table 1 below. An element is less easily oxidized than another element if it has a voltage value, E*, in the following table, that is greater than the element to which it is being compared.

TABLE 1

| Element | Half-cell reaction | Voltage, E* |
|---|---|---|
| Potassium | K⁺ + e → K | −2.93 |
| Calcium | Ca²⁺ + 2e → Ca | −2.87 |
| Sodium | Na⁺ + e → Na | −2.71 |
| Magnesium | Mg²⁺ + 2e → Mg | −2.37 |
| Aluminum | Al³⁺ + 3e → Al | −1.66 |
| Zinc | Zn²⁺ + 2e → Zn | −0.76 |
| Iron | Fe²⁺ + 2e → Fe | −0.44 |
| Nickel | Ni²⁺ + 2e → Ni | −0.25 |
| Tin | Sn²⁺ + 2e → Sn | −0.14 |
| Lead | Pb²⁺ + 2e → Pb | −0.13 |

Metal substrates that may be used in the present disclosure include, but are not limited to, cold rolled steel, hot rolled steel, steel coated with zinc metal, zinc compounds, or zinc alloys, hot-dipped galvanized steel, galvannealed steel, steel plated with zinc alloy, aluminum alloys, aluminum plated steel, aluminum alloy plated steel, magnesium and magnesium alloys. Suitable electropositive metals for deposition thereon include, for example, nickel, copper, silver, and gold, as well as mixtures thereof.

When the electropositive metal comprises copper, both soluble and insoluble compounds may serve as a source of copper in the cleaner-coater composition. For example, the supplying source of copper in the cleaner-coater composition may be a water-soluble copper compound. Specific examples of such compounds include, but are not limited to, copper sulfate, copper nitrate, copper thiocyanate, disodium copper ethylenediaminetetraacetate tetrahydrate, copper bromide, copper oxide, copper hydroxide, copper chloride, copper fluoride, copper gluconate, copper citrate, copper lauroyl sarcosinate, copper lactate, copper oxalate, copper tartrate, copper malate, copper succinate, copper malonate, copper maleate, copper benzoate, copper salicylate, copper amino acid complexes, copper fumarate, copper glycerophosphate, sodium copper chlorophyllin, copper fluorosilicate, copper fluoroborate and copper iodate, as well as copper salts of carboxylic acids such as in the homologous series formic acid to decanoic acid, and copper salts of polybasic acids in the series oxalic acid to suberic acid.

When copper supplied from such a water-soluble copper compound are precipitated as an impurity in the form of copper sulfate, copper oxide, etc., it may be desirable to add a complexing agent that suppresses the precipitation of copper, thus stabilizing them as a copper complex in the composition.

The copper compound may be added as a copper complex salt such as K₃Cu(CN)₄ or Cu-EDTA, which can be present stably, i.e., does not precipitate, in the cleaner-coater composition on its own, but it is also possible to form a copper complex that can be present stably in the cleaner-coater composition by combining a complexing agent with a compound that is difficult to solubilize on its own. Examples thereof include a copper cyanide complex formed by a combination of CuCN and KCN or a combination of CuSCN and KSCN or KCN, and a Cu-EDTA complex formed by a combination of CuSO₄ and EDTA·2Na.

The electropositive metal may be present in the cleaner-coater composition in an amount of at least 2 ppm based on the total weight of the cleaner-coater composition, such as at least 10 ppm, such as at least 20 ppm. The electropositive metal may be present in the cleaner-coater composition in an amount of no more than 200 ppm based on the total weight of the cleaner-coater composition, such as no more than 100 ppm, such as no more than 75 ppm, such as no more than 40 ppm. The electropositive metal may be present in the cleaner-coater composition in an amount of 2 ppm to 200 ppm based on the total weight of the cleaner-coater composition, such as 2 ppm to 75 ppm, such as 10 ppm to 100 ppm, such as 20 ppm to 75 ppm, such as 20 ppm to 40 ppm.

The cleaner-coater composition may comprise a surfactant. The surfactant may comprise a cationic surfactant, an anionic surfactant, a nonionic surfactant, an amphoteric surfactant, or combinations thereof. Suitable cationic surfactants include but are not limited to quaternary compounds (such as Tomamine Q-14-2, available from Evonik and Chemquat 508/40, available from the PCC Group) and ethoxylated amine (such as Tomamine E-14-2, available from Evonik). Suitable anionic surfactants include but are not limited to alkyl diphenyl sulfonates (such as Dowfax 2A1, available from The Dow Chemical Company), sulfates (such as Niaproof 08, available from Niacet), phosphate esters (such as Triton H-66, available from The Dow Chemical Company) and ethers (such as Triton DF20, available from The Dow Chemical Company). Suitable nonionic surfactants include but are not limited to alcohol ethoxylates (such as Tomadol-l-n or Tomadol 91-6, available from Evonik Industries, SEACO 9AE, available from Sea-Land Chemical Company, and Makon NF-12, available from Surfachem), and alkyl phenolethoxylates (such as Triton X100, available from The Dow Chemical Company). Suitable amphoteric surfactants include but are not limited to alkyl sultaines (such as Mirataine ASC and Mirataine CBS, available from Solvay).

The surfactant may be present in the cleaner-coater composition in an amount of at least 50 ppm based on total weight of the cleaner-coater composition, such as at least 100 ppm, such as at least 200 ppm, such as at least 500 ppm. The surfactant may be present in the cleaner-coater composition in an amount of no more than 20,000 ppm based on total weight of the cleaner-coater composition, such as no more than 10,000 ppm, such as no more than 7,500 ppm, such as no more than 5,000 ppm. The surfactant may be present in the cleaner-coater composition in an amount of 50 ppm to 20,000 ppm based on total weight of the cleaner-coater composition, such as 100 ppm to 10,000 ppm, such as 200 ppm to 7,500 ppm, such as 500 ppm to 5,000 ppm.

The cleaner-coater composition may comprise a builder. The builder may comprise, consist essentially of, or consist of a phosphonate, a phosphate such as sodium tripolyphosphate, a carbonate, a silicate, a polycarboxylate, a polyacrylate, a gluconate, a sugar alcohol, an aminocarboxylate, or combinations thereof. Suitable phosphonates may comprise a monophosphonate, a diphosphonate, a polyphosphonate, or combinations thereof.

The phosphonate may comprise a phosphonic acid. The phosphonic acid may comprise a monophosphonic acid, a diphosphonic acid, a polyphosphonic acid, or combinations thereof. In examples, the diphosphonic acid may comprise etidronic acid or derivatives thereof. Other suitable phosphonic acids may comprise ethylenediamine tetra(methylenephosphonic) acid (EDTMP), diethylenetriaminepenta(methylene-phosphonic acid) (DTPMPA), iminodi(methylphosphonic acid), N-(phosphonomethyl)iminodiacetic acid hydrate, (aminomethyl)phosphonic acid, glyphosate, methylenediphosphonic acid, N,N-bis(phosphonomethyl)glycine, glyphosine, 2-phosphono 1,2,4-butane tricarboxylic acid (PBTC), aminotris(methylenephosphonic acid) (ATMP aminotris), polyvinylphosphonic acid (PVPA), or combinations thereof.

The molecular weight (Mw) of the phosphonate may be at least 90 g/mol, such as at least 100 g/mol, such as at least 150 g/mol, such as at least 200 g/mol. The Mw of the phosphonate may be no more than 50,000 g/mol, such as no more than 40,000 g/mol, such as no more than 30,000 g/mol, such as no more than 1,000 g/mol, such as no more than 600 g/mol. The Mw of the phosphonate may be in the range of 90 g/mol to 50,000 g/mol, such as 100 g/mol to 40,000 g/mol, such as 150 g/mol to 30.00 g/mol, such as 150 g/mol to 600 g/mol, such as 200 g/mol to 1,000 g/mol, such as 200 g/mol to 600 g/mol. As used herein, “Mw” refers to the weight average molecular weight and means the theoretical value as determined by Gel Permeation Chromatography using Waters 2695 separation module with a Waters 410 differential refractometer (RI detector), using polystyrene standards, tetrahydrofuran (THF) as the eluent at a flow rate of 1 ml min-¹, and two PL Gel Mixed C columns for separation.

The builder may be present in the cleaner-coater composition in an amount of at least 10 ppm based on total weight of the cleaner-coater composition, such as at least 30 ppm, such as at least 50 ppm. The builder may be present in the cleaner-coater composition in an amount of no more than 2,500 ppm based on total weight of the cleaner-coater composition, such as no more than 2,000 ppm, such as no more than 1,500 ppm. The builder may be present in the cleaner-coater composition in an amount of 10 ppm to 2,500 ppm based on total weight of the cleaner-coater composition, such as 30 ppm to 2,000 ppm, such as 50 ppm to 1,500 ppm.

The cleaner-coater composition may optionally comprise fluoride. Fluoride may be measured as total fluoride, which comprises both free fluoride and bound fluoride. As used herein, “free fluoride” means fluoride that is present in the cleaner-coater composition that is not bound to metal ions or hydrogen ions. As used herein, “bound fluoride” means fluoride that comprises fluoride anions in solution that are ionically or covalently bound to metal cations or hydrogen ions. The fluoride ions thus complexed are not measurable with a fluoride ion selective electrode (ISE) unless the solution they are present in is mixed with an ionic strength adjustment buffer (e.g., citrate anion or EDTA) that releases the fluoride ions from such complexes, at which point the fluoride ions are measurable by the fluoride ISE, and the measurement is known as “total fluoride.” Alternatively, the total fluoride can be calculated by comparing the weight of the fluoride supplied in the cleaner-coater composition by the total weight of the cleaner-coater composition.

In examples, free fluoride may be measured as an operational parameter in the cleaner-coater composition bath using, for example, an Orion Dual Star Dual Channel Benchtop Meter equipped with a fluoride ion selective electrode (“ISE”) available from Thermoscientific, the symphony@ Fluoride Ion Selective Combination Electrode supplied by VWR International, or similar electrodes. See, e.g., Light and Cappuccino, Determination of fluoride in toothpaste using an ion-selective electrode, J. Chem. Educ., 52:4, 247-50, April 1975. The fluoride ISE may be standardized by immersing the electrode into solutions of known fluoride concentration and recording the reading in millivolts, and then plotting these millivolt readings in a logarithmic graph. The millivolt reading of an unknown sample can then be compared to this calibration graph and the concentration of fluoride determined. Alternatively, the fluoride ISE can be used with a meter that will perform the calibration calculations internally and thus, after calibration, the concentration of the unknown sample can be read directly.

Free fluoride in the cleaner-coater composition may be derived from Group IVB metal sources present in the cleaner-coater composition, including, for example, hexafluorozirconic acid or hexafluorotitanic acid. Additionally, other complex fluorides, such as H₂SiF₆, KHF₂ or HBF₄, can be added to the cleaner-coater composition to supply free fluoride. The skilled artisan will understand that the presence of free fluoride in the cleaner-coater bath can impact zirconium deposition and etching of the substrate, hence it is critical to measure this bath parameter. The levels of free fluoride will depend on the pH and the addition of chelators into the cleaner-coater bath and indicate the degree of fluoride association with the metal ions/protons present in the cleaner-coater bath.

The total fluoride of the cleaner-coater composition may be present in an amount of at least 60 ppm based on total weight of the cleaner-coater composition, such as at least 125 ppm, such as at least 200 ppm, such as at least 250 ppm. The total fluoride of the cleaner-coater composition may be present in an amount of no more than 10,000 ppm based on total weight of the cleaner-coater composition, such as no more than 7,500 ppm, such as no more than 5,000 ppm, such as no more than 3,000 ppm, such as no more than 2,500 ppm. The total fluoride of the cleaner-coater composition may be present in an amount of 60 ppm to 10,000 ppm based on total weight of the cleaner-coater composition, such as 125 ppm to 7,500 ppm, such as 200 ppm to 5,000 ppm, such as 250 ppm to 3,000 ppm, such as 250 ppm to 2,500 ppm.

The free fluoride of the cleaner-coater composition may be present in an amount of at least 25 ppm based on total weight of the cleaner-coater composition, such as at least 35 ppm, such as at least 50 ppm. The free fluoride of the cleaner-coater composition may be present in an amount of no more than 750 ppm based on total weight of the cleaner-coater composition, such as no more than 600 ppm, such as no more than 500 ppm. The free fluoride of the cleaner-coater composition may be present in an amount of 25 ppm to 750 ppm based on total weight of the cleaner-coater composition, such as 35 ppm to 600 ppm, such as 50 ppm to 500 ppm.

The cleaner-coater composition optionally may further comprise lithium. The source of lithium metal in the cleaner-coater composition may be in the form of a salt. Non-limiting examples of suitable lithium salts include lithium nitrate, lithium sulfate, lithium fluoride, lithium chloride, lithium hydroxide, lithium carbonate, lithium iodide, and combinations thereof.

The lithium may be present in the cleaner-coater composition in an amount of at least 2 ppm based on total weight of the cleaner-coater composition, such as at least 5 ppm, such as at least 25 ppm, such as at least 75 ppm. The lithium may be present in the cleaner-coater in an amount of no more than 1,000 ppm based on total weight of the cleaner-coater composition, such as no more than 500 ppm, such as no more than 250 ppm, such as no more than 125 ppm, such as no more than 100 ppm. The lithium may be present in the cleaner-coater composition in an amount of 2 ppm to 1,000 ppm based on total weight of the cleaner-coater composition, such as 5 ppm to 500 ppm, such as 5 ppm to 250 ppm, such as 25 ppm to 125 ppm, such as 75 ppm to 125 ppm, such as 75 ppm to 100 ppm.

The cleaner-coater composition may optionally comprise molybdenum. The source of molybdenum in the cleaner-coater composition may be in the form of a salt. Non-limiting examples of suitable molybdenum salts include sodium molybdate, lithium molybdate, calcium molybdate, potassium molybdate, ammonium molybdate, molybdenum chloride, molybdenum acetate, molybdenum sulfamate, molybdenum formate, molybdenum lactate, and combinations thereof.

The molybdenum may be present in the cleaner-coater composition in an amount of at least 5 ppm based on total weight of the cleaner-coater composition, such as at least 25 ppm, such as at least 50 ppm, such as at least 100 ppm. The molybdenum may be present in the cleaner-coater composition in an amount of no more than 5,000 ppm based on total weight of the cleaner-coater composition, such as no more than 2,500 ppm, such as no more than 500 ppm, such as no more than 250 ppm, such as no more than 150 ppm. The molybdenum may be present in the cleaner-coater composition in an amount of 5 ppm to 5,000 ppm based on total weight of the cleaner-coater composition, such as 25 ppm to 2,500 ppm, such as 50 ppm to 500 ppm, such as 25 ppm to 250 ppm, such as 100 ppm to 150 ppm.

The cleaner-coater composition may comprise a pH of at least 1.0, such as at least 1.5, such as at least 2.0, such as at least 3.0, such as at least 3.5, such as at least 4.0. The cleaner-coater composition may comprise a pH of no more than 6.0, such as no more than 5.5, such as no more than 5.0, such as no more than 4.5, such as no more than 3.5. The cleaner-coater composition may comprise a pH of 1.0 to 6.0, such as 1.5 to 6.0, such as 2.0 to 5.0, such as 3.0 to 5.0, such as 1.0 to 5.0, such as 1.5 to 4.5, such as 2.0 to 3.5, such as 4.0 to 6.0, such as 4.0 to 5.5, such as 4.0 to 5.0. The pH recited herein may be measured using a pH meter (interface, DualStar pH/ISE Dual Channel Benchtop Meter, available from ThermoFisher Scientific, Waitham, MA, USA) and pH probe (Fisher Scientific ACCUMET pH probe (Ag/AgCl reference electrode)) at ambient conditions. The pH of the cleaner-coater composition may be maintained through the inclusion of an acidic material, including water soluble and/or water dispersible acids, such as nitric acid, sulfuric acid, and/or phosphoric acid. The pH of the cleaner-coater composition may be maintained through the inclusion of a basic material, including water soluble and/or water dispersible bases, such as sodium hydroxide, sodium carbonate, potassium hydroxide, ammonium hydroxide, ammonia, and/or amines such as triethylamine, methylethyl amine, or mixtures thereof.

The cleaner-coater composition may, in some instances, exclude phosphate ions or phosphate-containing compounds and/or the formation of sludge, such as aluminum phosphate, iron phosphate, and/or zinc phosphate, formed in the case of using a treating agent based on zinc phosphate. As used herein, “phosphate-containing compounds” include compounds containing the element phosphorous such as orthophosphate, pyrophosphate, metaphosphate, tripolyphosphate, and the like, and can include, but are not limited to, monovalent, divalent, or trivalent cations such as: sodium, potassium, calcium, zinc, nickel, manganese, aluminum, and/or iron. When a composition and/or a material deposited on a substrate surface by deposition of the cleaner-coater composition is substantially free, essentially free, or completely free of phosphate, this includes phosphate ions or compounds containing phosphate in any form.

Thus, the cleaner-coater composition and/or a coating deposited on a substrate surface by deposition of the cleaner-coater composition may be substantially free, or in some cases may be essentially free, or in some cases may be completely free, of one or more of any of the ions or compounds listed in the preceding paragraph. A cleaner-coater composition and/or coating that is substantially free of phosphate means that phosphate ions or compounds containing phosphate are not intentionally added, but may be present in trace amounts, such as because of impurities or unavoidable contamination from the environment. In other words, the amount of material is so small that it does not affect the properties of the composition. This may further include that phosphate is not present in the cleaner-coater composition and/or deposited materials in such a level that they cause a burden on the environment. The term “substantially free” means that the cleaner-coater composition and/or coating contains less than 5 ppm of any or all the phosphate anions or compounds listed in the preceding paragraph based on total weight of the composition or the deposited material, respectively, if any at all. The term “essentially free” means that the cleaner-coater compositions and/or coating contains less than 1 ppm of any or all the phosphate anions or compounds listed in the preceding paragraph. The term “completely free” means that the cleaner-coater composition and/or coating contains less than 1 ppb of any or all the phosphate anions or compounds listed in the preceding paragraph, if any at all.

The cleaner-coater composition may exclude chromium or chromium-containing compounds. That is, the cleaner-coater composition and/or coatings deposited from the cleaner-coater composition may be substantially free, may be essentially free, and/or may be completely free of such chromium or chromium-containing compounds. As used herein, the term “chromium-containing compound” refers to materials that include trivalent and/or hexavalent chromium. Non-limiting examples of such materials include chromic acid, chromium trioxide, chromic acid anhydride, dichromate salts, such as ammonium dichromate, sodium dichromate, potassium dichromate, and calcium, barium, magnesium, zinc, cadmium, strontium dichromate, chromium (III) sulfate, chromium (III) chloride, and chromium (III) nitrate. When a cleaner-coater composition or coating deposited by the cleaner-coater composition is substantially free, essentially free, or completely free of chromium, this includes chromium in any form, such as, but not limited to, the trivalent and hexavalent chromium-containing compounds listed above.

Thus, optionally, the cleaner-coater compositions and/or coating may be substantially free, may be essentially free, and/or may be completely free of one or more of any of the elements or compounds in the preceding paragraph. A cleaner-coater composition or coating that is substantially free of chromium or derivates thereof means that chromium or derivatives thereof are not intentionally added, but may be present in trace amount, such as because of impurities or unavoidable contamination from the environment. In other words, the amount of material is so small that it does not affect the properties of the cleaner-coater composition or coating. In the case of chromium, this may further include that the element or compounds thereof are not present in the cleaner-coater compositions and/or coating in such a level that it causes a burden on the environment. The term “substantially free” means that the cleaner-coater composition and/or coating contains less than 10 ppm of any or all the elements or compounds listed in the preceding paragraph based on total weight of the composition or the coating, respectively, if any at all. The term “essentially free” means that the cleaner-coater composition and/or coating contains less than 1 ppm of any or all the elements or compounds listed in the preceding paragraph, if any at all. The term “completely free” means that the cleaner-coater composition and/or coating comprises 0 ppm of such material or that such material is below the detection limit of common analytical techniques.

The cleaner-coater composition may comprise an aqueous medium and may optionally contain other materials such as auxiliaries conventionally used in the art of pretreatment compositions. In the aqueous composition, water dispersible organic solvents, for example, alcohols with up to about 8 carbon atoms such as methanol, isopropanol, and the like, may be present, or glycol ethers such as the monoalkyl ethers of ethylene glycol, diethylene glycol, or propylene glycol, and the like. When present, water dispersible organic solvents are typically used in amounts up to about ten percent by volume, based on the total volume of aqueous composition.

The cleaner-coater composition also may comprise a resinous binder. Suitable resins include reaction products of one or more alkanolamines and an epoxy-functional material containing at least two epoxy groups, such as those disclosed in U.S. Pat. No. 5,653,823. In some cases, such resins contain beta hydroxy ester, imide, or sulfide functionality, incorporated by using dimethylolpropionic acid, phthalimide, or mercaptoglycerine as an additional reactant in the preparation of the resin. Alternatively, the reaction product is that of the diglycidyl ether of Bisphenol A (commercially available from Shell Chemical Company as EPON 880), dimethylol propionic acid, and diethanolamine in a 0.6 to 5.0:0.05 to 5.5:1 mole ratio. Other suitable resinous binders include water soluble and water dispersible polyacrylic acids as disclosed in U.S. Pat. Nos. 3,912,548 and 5,328,525; phenol formaldehyde resins as described in U.S. Pat. No. 5,662,746; water soluble polyamides such as those disclosed in WO 95/33869; copolymers of maleic or acrylic acid with allyl ether as described in Canadian patent application 2,087,352; and water soluble and dispersible resins including epoxy resins, aminoplasts, phenol-formaldehyde resins, tannins, and polyvinyl phenols as discussed in U.S. Pat. No. 5,449,415.

The resinous binder often may be present in the cleaner-coater composition in an amount of 0.005 to 30 percent by weight, such as 0.5 to 3 percent by weight, based on the total weight of the ingredients in the cleaner-coater composition.

The cleaner-coater composition may be substantially free or, in some cases, completely free of any resinous binder. As used herein, the term “substantially free,” when used with reference to the absence of resinous binder in the cleaner-coater composition, means that any resinous binder is present in the cleaner-coater composition in a trace amount of less than 0.005 percent by weight. As used herein, the term “completely free” means that there is no detectable resinous binder in the cleaner-coater composition at all.

The cleaner-coater composition may be substantially free, essentially free, or completely free of sodium nitrobenzene sulfonate.

### Electrodepositable Coating Composition

As stated above, the system for treating a substrate comprises an electrodepositable coating composition.

As used herein, the term “electrodepositable coating composition” refers to a composition that is capable of being deposited onto an electrically conductive substrate under the influence of an electrical potential applied between two electrodes immersed in the electrodepositable coating composition, where one of the electrodes is the substrate to be coated.

The electrodepositable coating composition comprises an electrodepositable binder. For example, the electrodepositable binder may comprise an organic and/or inorganic electrodepositable binder. As used herein, the term “binder” refers to the non-volatile content, excluding fillers, of the electrodepositable coating composition.

As used herein, an “organic” electrodepositable binder refers to a film-forming polymer with a skeletal structure that includes a carbon atom in the backbone. As used herein, an “inorganic” electrodepositable binder refers to a film-forming polymer with a skeletal structure that does not include carbon atoms in the backbone, such as silicone-based materials. It will be understood that the electrodepositable binder may also comprise a mixture of organic and inorganic film-forming and/or curing agent materials.

As used herein, the term “film-forming polymer” is used interchangeably with “polymer” or “resin”, and refers to one or more polymers, such as homopolymers and/or copolymers, as well as prepolymers, oligomers, and monomers, that are capable of forming a coating upon reaction with a curing agent or crosslinker. As used herein, the term “crosslinker”, “crosslinking agent”, or “curing agent” refers to a molecule capable of forming a covalent linkage between polymers. For example, a polyisocyanate curing agent may react with active hydrogen groups on a film-forming polymer to effectuate a cure of the coating composition to form a coating. As used herein, the term “cure”, “cured” or similar terms, means that a portion of the coating composition is crosslinked to form a coating.

The electrodepositable coating composition may comprise an ionic salt group-containing film-forming polymer, such as a cationic salt group containing film-forming polymer or an anionic salt group containing film-forming polymer.

For example, the ionic salt group-containing film-forming polymer may comprise a reaction product of reactants comprising (a) a polyepoxide; (b) a di-functional chain extender; and (c) a mono-functional reactant. Non-limiting examples of such polymers are provided in Int′l App. No. PCT/US22/73356, at paragraphs [0023] to [0038], the cited portion of which is incorporated herein by reference.

As used herein, the term “cationic salt group-containing film-forming polymer” refers to polymers that include at least partially neutralized cationic salt groups, such as amine, sulfonium and/or ammonium salt groups, that impart a positive charge. The cationic salt group-containing film-forming polymer may comprise active hydrogen functional groups. As used herein, the term “active hydrogen functional groups” refers to those functional groups that are reactive with isocyanates, and include, for example, hydroxyl groups, primary or secondary amine groups, carbamate, and thiol groups.

Non-limiting examples of polymers that are suitable for use as the cationic salt group-containing film-forming polymer of the electrodepositable coating composition include, but are not limited to, alkyd polymers, acrylics, polyepoxides, polyamides, polyurethanes, polyureas, polyethers, and polyesters, as well as adducts, derivatives and combinations thereof.

The cationic salt group-containing film-forming polymer may be made cationic and water dispersible by at least partial neutralization with an acid such as formic acid, acetic acid, methanesulfonic acid, lactic acid, phosphoric acid and/or sulfamic acid.

The extent of neutralization of the cationic salt group-containing film-forming polymer may vary with the particular polymer involved. However, sufficient acid should be used to neutralize the cationic salt group-containing film-forming polymer such that the cationic salt group-containing film-forming polymer may be dispersed in an aqueous dispersing medium. For example, the amount of acid used may provide at least 20% of all of the total theoretical neutralization. Alternatively, the amount of acid used may provide in excess of 100% of all of the total theoretical neutralization. The total amount of acid used to neutralize the cationic salt group-containing film-forming polymer may range between any combination of values, for example, such as at 20% or more, to, such as greater than 100%, is inclusive of the recited values. For example, the total amount of acid used to neutralize the active hydrogen-containing, cationic salt group-containing film-forming polymer may be 20%, 35%, 50%, 60%, 80%, or 100% or greater, based on the total amines in the cationic salt group-containing film-forming polymer.

As used herein, the term “anionic salt group-containing film-forming polymer” refers to an anionic polymer comprising at least partially neutralized anionic functional groups, such as carboxylic acid and/or phosphoric acid groups that impart a negative charge. The anionic salt group-containing film-forming polymer may comprise active hydrogen functional groups.

Non-limiting examples of polymers that are suitable for use as the anionic salt group-containing film-forming polymer of the electrodepositable binder include, but are not limited to, drying and/or semi-drying, and/or saturated alkyd polymers, acrylics, polyepoxides, polyamides, polyurethanes, polyureas, polyethers, polyesters, resinous polyols, phosphatized polyepoxides, and phosphatized acrylic polymers, vehicles comprising alkyds and amine-aldehydes, as well as adducts, derivatives and combinations thereof.

Non-limiting examples of inorganic electrodepositable film-forming polymers include silicone-based film-forming polymers. Non-limiting examples of such polymers are described in Int′l Pub. No. WO 2021/138384 A1, at paragraphs [0007] through [0029], the cited portion of which is incorporated herein by reference.

The ionic salt group-containing film-forming polymer may be present in the electrodepositable coating composition in an amount of at least 40% by weight, such as at least 50% by weight, such as at least 55% by weight, such as at least 60% by weight, based on the total weight of the resin solids of the electrodepositable coating composition. The ionic salt group-containing film-forming polymer may be present in the electrodepositable coating composition in an amount of no more than 90% by weight, such as no more than 80% by weight, such as no more than 75% by weight, based on the total weight of the resin solids of the electrodepositable coating composition. The ionic salt group-containing film-forming polymer may be present in the electrodepositable coating composition, in an amount of 40% to 90% by weight, such as 40% to 80% by weight, such as 40% to 75% by weight, such as 50% to 90% by weight, such as 50% to 80% by weight, such as 50% to 75% by weight, such as 55% to 90% by weight, such as 55% to 80% by weight, such as 55% to 75% by weight, such as 60% to 90% by weight, such as 60% to 80% by weight, such as 60% to 75% by weight, based on the total weight of the resin solids of the electrodepositable coating composition.

As used herein, the “resin solids” include the ionic salt group-containing film-forming polymer, the curing agent, and any additional water-dispersible non-pigmented component(s) present in the electrodepositable coating composition.

The electrodepositable coating composition of the present disclosure may further comprise a curing agent. The curing agent may react with the reactive groups, such as active hydrogen groups, of the ionic salt group-containing film-forming polymer as well as any reactive groups, if present, of any additional resinous materials, to effectuate cure of the electrodepositable coating composition to form a coating. Non-limiting examples of suitable curing agents include partially or fully blocked polyisocyanates, as well as aminoplast resins, and/or phenoplast resins, such as phenolformaldehyde condensates including allyl ether and/or derivatives thereof.

As used herein, a “blocked polyisocyanate” means a polyisocyanate wherein at least a portion of the isocyanato groups is blocked by a blocking group introduced by the reaction of a free isocyanato group of the polyisocyanate with a blocking agent. By “blocked” is meant that the isocyanato groups have been reacted with a blocking agent such that the resultant blocked isocyanate group is stable to active hydrogens at ambient temperature, e.g., room temperature (23° C.). The reaction may be reversed under suitable conditions, such as at elevated temperatures, such as, e.g., between 90° C. and 200° C., such that the previously blocked isocyanato groups on the polyisocyanate curing agent are unblocked and available to react with the reactive groups, such as active hydrogen groups, of the ionic salt group-containing film-forming polymer to effectuate cure of the coating composition to form a coating.

Blocking agents that are disassociated from the blocked polyisocyanate curing agent during cure may be removed from the coating by volatilization. Alternatively, at least a portion of the blocking agent may remain in the coating following cure.

Non-limiting examples of blocked polyisocyanate curing agents, and amounts thereof, including suitable polyisocyanates, and blocking components such as blocking groups and/or blocking agents, such as but not limited to 1,2 polyols, are provided in Int′l Pub. No. WO 2021/138583 A1, at paragraphs [0022] to [0035], the cited portion of which is incorporated herein by reference.

Non-limiting examples of blocked polyisocyanates comprising a blocking group derived from a blocking agent comprising an alpha-hydroxy amide, ester, or thioester and, optionally, a second blocking agent, are provided in Int′l Pub. No. WO 2018/148306 A 1, at paragraphs [0010] to [0029], the cited portion of which is incorporated herein by reference. The blocked polyisocyanate may be a fully blocked polyisocyanate wherein essentially 100% of the isocyanato groups of the polyisocyanate are blocked with one or more blocking groups. Optionally, the blocked polyisocyanate curing agent may be an at least partially blocked polyisocyanate, having fewer than 100% of the isocyanato groups blocked, as long as the coating composition remains a stable dispersion.

The at least partially blocked polyisocyanate may be partially blocked with one or more of the blocking groups discussed above, with the remaining isocyanato groups reacted with the polymer backbone, such as described in U.S. Pat. No. 3,947,338, at col. 2, line 65 through col. 5, line 33, the cited portion of which is herein incorporated by reference.

The blocked polyisocyanate curing agent may comprise a tris(alkoxycarbonylamino)-1,3,5-triazine (TACT). Non-limiting examples of suitable tris(alkoxycarbonylamino)-1,3,5-triazines include tris(methoxycarbonylamino)-, tris(butoxycarbonylamino)-, and tris(2-ethylhexoxycarbonylamino)-1,3,5-triazines, and any combination thereof.

The curing agent may comprise an aminoplast or a phenoplast resin. Aminoplast resins are condensation products of an aldehyde with an amino- or amido-group carrying substance. Phenoplast resins are formed by the condensation of an aldehyde and a phenol.

Non-limiting examples of commercially available aminoplast resins include those available under the trademark CYMEL® from Allnex Belgium SA/NV, such as CYMEL 1130 and 1156, and RESIMENE@ from INEOS Melamines, such as RESIMENE 750 and 753. Examples of suitable aminoplast resins, and amounts thereof, also include those described in U.S. Pat. No. 3,937,679 at col. 16, line 3 to col. 17, line 47, this portion of which being hereby incorporated by reference. As is disclosed in the aforementioned portion of the '679 patent, the aminoplast may be used in combination with the methylol phenol ethers.

Suitable aminoplast and phenoplast resins also are described in U.S. Pat. No. 4,812,215 at col.6, line 20 to col. 7, line 12, the cited portion of which being incorporated herein by reference.

Non-limiting examples of additional curing agents including silicone-based curing agents. Non-limiting examples of such curing agents are described in Int′l Pub. No. WO 2021/138384 A1, at paragraphs [0030] through [0043], the cited portion of which is incorporated herein by reference.

The curing agent may be present in the electrodepositable coating composition in an amount of at least 10% by weight, such as at least 20% by weight, such as at least 25% by weight, based on the total weight of the resin solids of the electrodepositable coating composition. The curing agent may be present in the electrodepositable coating composition, in an amount of no more than 60% by weight, such as no more than 50% by weight, such as no more than 45% by weight, such as no more than 40% by weight, based on the total weight of the resin solids of the electrodepositable coating composition. The curing agent may be present in the electrodepositable coating composition, in an amount of 10% to 60% by weight, such as 10% to 50% by weight, such as 10% to 45% by weight, such as 10% to 40% by weight, such as 20% to 60% by weight, such as 20% to 50% by weight, such as 20% to 45% by weight, such as 20% to 40% by weight, such as 25% to 60% by weight, such as 25% to 50% by weight, such as 25% to 45% by weight, such as 25% to 40% by weight, based on the total weight of the resin solids of the electrodepositable coating composition.

The electrodepositable coating composition further comprises a curing catalyst. As used herein, the term “curing catalyst” is used interchangeably with “catalyst” and refers to a substance that increases the rate or decreases the activation energy of a chemical reaction without itself undergoing any permanent chemical change. For example, the catalyst may catalyze transurethanation reactions, and specifically catalyze the deblocking of blocked polyisocyanate blocking groups.

Non-limiting examples of curing catalysts include amine-containing compounds; compounds or complexes of metals such as tin, bismuth, cerium, zinc, and/or titanium; and combinations thereof.

Catalysts suitable for cationic electrodepositable coating compositions include, without limitation, metal oxides (e.g., oxides of cerium, zirconium and bismuth) and salts thereof; zinc compounds or complexes; and/or a cyclic guanidine as described in U.S. Pat. No. 7,842,762 at col. 1, line 53 to col. 4, line 18 and col. 16, line 62 to col. 19, line 8, the cited portions of which being incorporated herein by reference.

Catalysts suitable for anionic electrodepositable coating compositions include, without limitation, latent acid catalysts. Latent acid catalysts are derivatives of acid catalysts that are generally activated by heating. Non-limiting examples of latent acid catalysts are identified in WO 2007/118024 at paragraph [0031]. Further examples of suitable latent acid catalysts include derivatives of acid catalysts such as sulfonic acids, such as derivatives of para-toluenesulfonic acid, such as pyridinium para-toluenesulfonate.

The amine-containing curing catalyst may comprise any suitable amine-containing curing catalyst, such as, but not limited to, curing catalysts comprising a guanidine, an imidazole, an amidine, and/or derivatives or combinations thereof.

Non-limiting examples of suitable guanidine curing catalysts are provided in Int′l Pub. No. WO 2018/0172519 A1, at paragraphs [0039] to [0050], the cited portion of which is incorporated herein by reference.

Non-limiting examples of imidazole curing catalysts are described in US Pub. No. 2022/0154014 A1, as paragraphs [0062] to [0108], the cited portion of which is incorporated herein by reference.

The amidine curing catalyst may, in a non-limiting example, comprise 1,8-diazabicyclo[5.4.0]undec-7-ene (DBU).

The zinc-containing catalyst may comprise a metal salt and/or complex of zinc such as, but not limited to, a zinc (II) amidine complex, zinc octoate, zinc naphthenate, zinc tallate, zinc carboxylates having from 8 to 14 carbons in the carboxylate group, zinc acetate, zinc sulfonates, zinc methanesulfonates, or any combination thereof. The zinc (II) amidine complex may contain amidine and carboxylate ligands.

The curing catalyst may comprise a bismuth catalyst. Non-limiting examples of bismuth curing catalysts, and amounts thereof, are provided in Int′l Pub. No. WO 2021/138583 A1, at paragraphs [0036] to [0050], the cited portion of which is incorporated herein by reference.

The curing catalyst may comprise a titanium compound and/or complex such as, for example, Ti(OR¹)₄, wherein R¹ is an alkyl or aryl, such as wherein R¹ is a C3-C20 alkyl, such as wherein R¹ is n-butyl, such as tetrabutyl titanate.

The curing catalyst may be present in the electrodepositable coating composition in any suitable amount. For example, the amine and/or the zinc-containing curing catalyst may be present in the coating composition in an amount of at least 0.1% by weight, based on the total weight of the resin solids of the coating composition, such as at least 0.2% by weight, such as at least 0.5% by weight, such as at least 0.8% by weight, such as at least 1% by weight, such as at least 1.5% by weight. The amine and/or zinc-containing curing catalyst may be present in the coating composition in an amount of no more than 7% by weight, based on the total weight of the resin solids of the coating composition, such as no more than 4% by weight, such as no more than 2% by weight, such as no more than 1.5% by weight, such as no more than 1% by weight. The amine and/or zinc-containing curing catalyst may be present in the coating composition in an amount of 0.1% to 7% by weight, based on the total weight of the resin solids of the coating composition, such as 0.1% to 4% by weight, such as 0.1% to 2% by weight, such as 0.1% to 1.5% by weight, such as 0.1% to 1% by weight, such as 0.2% to 7% by weight, such as 0.2% to 4% by weight, such as 0.2% to 2% by weight, such as 0.2% to 1.5% by weight, such as 0.2% to 1% by weight, such as 0.5% to 7% by weight, such as 0.5% to 4% by weight, such as 0.5% to 2% by weight, such as 0.5% to 1.5% by weight, such as 0.5% to 1% by weight, such as 0.8% to 7% by weight, such as 0.8% to 4% by weight, such as 0.8% to 2% by weight, such as 0.8% to 1.5% by weight, such as 0.8% to 1% by weight, such as 1% to 7% by weight, such as 1% to 4% by weight, such as 1% to 2% by weight, such as 1% to 1.5% by weight, such as 1.5% to 7% by weight, such as 1.5% to 4% by weight, such as 1.5% to 2% by weight.

The electrodepositable coating composition may be substantially free, essentially free, or completely free of catalytic tin. As used herein, the electrodepositable coating composition is “substantially free” of catalytic tin if catalytic tin is present in an amount of less than 0.1% by weight, based on the total weight of the electrodepositable coating composition. As used herein, the electrodepositable coating composition is “essentially free” of catalytic tin if catalytic tin is present in an amount of less than 0.01%, based on the total weight of the electrodepositable coating composition. As used herein, the electrodepositable coating composition is “completely free” of catalytic tin if catalytic tin is present in an amount of less than 0.001%, based on the total weight of the electrodepositable coating composition.

The electrodepositable coating composition may optionally further comprise a polymer comprising at least one phosphorylated group. The polymer is not limited. Non-limiting examples of the polymer include an addition polymer comprising at least one phosphorylated group, a phosphatized epoxy resin, as well as other polymers comprising at least one phosphorylated group.

The polymer may have a phosphorus acid equivalent weight of at least 0.01 milliequivalents per gram of polymer, such as at least 0.05, such as at least 0.1, such as at least 1, such as at least 2, such as at least 4. The polymer may have a phosphorus acid equivalent weight of no more than 10 milliequivalents per gram of polymer, such as no more than 7, such as no more than 5, such as no more than 3, such as no more than 2, such as no more than 1. The polymer may have a phosphorus acid equivalent weight of 0.01 to 10 milliequivalents per gram of polymer, such as 0.01 to 7, such as 0.01 to 5, such as 0.01 to 3, such as 0.01 to 2, such as 0.01 to 1, such as 0.05 to 10, such as 0.05 to 7, such as 0.05 to 5, such as 0.05 to 3, such as 0.05 to 2, such as 0.05 to 1, such as 0.1 to 10, such as 0.1 to 7, such as 0.1 to 5, such as 0.1 to 3, such as 0.1 to 2, such as 0.1 to 1, such as 1 to 10, such as 1 to 7, such as 1 to 5, such as 1 to 3, such as 1 to 2, such as 2 to 10, such as 2 to 7, such as 2 to 5, such as 2 to 3, such as 4 to 10, such as 4 to 7, such as 4 to 5. The phosphorous acid equivalent weight may be determined by dividing the total weight of the polymer by the total number of phosphorous acid groups present in the polymer.

As used herein, the term “phosphorylated group” and “phosphorus acid group” refers to a phosphate group attached to the polymer. As used herein, “phosphate” refers to anions derived from phosphoric acid having the general chemical formula [PO₄]³⁻, [HPO₄]²⁻, and/or [H₂PO₄]⁻. Although reference herein is to “phosphate” ions, derivatives of other phosphorus acid derivatives are within the scope of the disclosure. Accordingly, unless specified otherwise, the phosphate ions may refer to phosphonate anions derived from phosphonic acid having the general chemical formula [RPO₃]²⁻ and/or [RHPO₃]¹⁻, and phosphinate anions derived from phosphinic acid.

The polymer comprising at least one phosphorylated group may comprise an addition polymer.

As used herein, the term “addition polymer” refers to a polymerization product formed by the polymerization reaction of monomers comprising a monomer composition to form a polymer. Following polymerization of the monomers of the monomer composition, the addition polymer comprises constitutional units corresponding to the residue of each polymerized monomer. As used herein, the term “residue of” when referring to the composition of a polymer refers to a singular molecular unit (i.e., constitutional unit) within the polymer that results from incorporation (i.e., reaction) of a monomer during polymerization. The addition polymer is formed by polymerizing a monomer composition that includes ethylenically unsaturated monomers.

The monomer composition comprises a phosphorus acid-functional monomer. The phosphorus acid group may comprise a phosphonic acid group, a phosphinic acid group, or combinations thereof, as well as salts thereof. The phosphorus acid-functional ethylenically unsaturated monomer may be dihydrogen phosphate esters of an alcohol in which the alcohol contains or is substituted with a polymerizable vinyl or olefinic group. Suitable phosphorus acid-functional ethylenically unsaturated monomer may include phosphoalkyl (meth)acrylates such as phosphoethyl (meth)acrylate, phosphopropyl (meth)acrylate, phosphobutyl (meth)acrylate, salts of phosphoalkyl (meth)acrylates, and mixtures thereof; CH₂═C(R)—C(O)—O—(RₚO)ₙ—P(O)(OH)₂, wherein R═H or CH₃ and Rₚ═alkyl, n is from 1 to 20, such as SIPOMER PAM-100, SIPOMER PAM-200, SIPOMER PAM-300, and SIPOMER PAM-4000 all available from Solvay; phosphoalkoxy (meth)acrylates such as phospho ethylene glycol (meth)acrylate, phospho di-ethylene glycol (meth)acrylate, phospho tri-ethylene glycol (meth)acrylate, phospho propylene glycol (meth)acrylate, phospho dipropylene glycol (meth)acrylate, phospho tri-propylene glycol (meth)acrylate, salts thereof, and mixtures thereof. The phosphorus acid-functional monomer may be present in the monomer composition in an amount of at least 0.1% by weight, such as at least 1% by weight, such as at least 2% by weight, based on the total weight of the monomer composition. The phosphorus acid-functional monomer may be present in the monomer composition in an amount of no more than 20% by weight, such as no more than 10% by weight, such as no more than 8% by weight, based on the total weight of the monomer composition. The phosphorus acid-functional monomer may be present in the monomer composition in an amount of 0.1% to 20% by weight, such as 0.1% to 10% by weight, such as 0.1% to 8% by weight, such as 1% to 20% by weight, such as 1% to 10% by weight, such as 1% to 8% by weight, such as 2% to 20% by weight, such as 2% to 10% by weight, such as 2% to 8% by weight, based on the total weight of the monomer composition.

The monomer composition, and resulting addition polymer, may further comprise at least one other ethylenically unsaturated monomer. For example, the monomer composition and resulting addition polymer may further comprise a C₁-C₁₈ alkyl (meth)acrylate monomer; a hydroxyl-functional (meth)acrylate monomer; a vinyl aromatic compound; a monomer comprising two or more ethylenically unsaturated groups per molecule; a (meth)acrylamide monomer; a monoalkyl (meth)acrylamide monomer; a dialkyl (meth)acrylamide monomer; and/or a hydroxyl-functional (meth)acrylamide monomer.

As used herein, “(meth)acrylate” or “(meth)acrylamide” and like terms encompasses both acrylates and methacrylates or acrylamides and methacrylamides, respectively.

The electrodepositable coating composition may further comprise a pigment. Non-limiting examples of pigment include, for example, iron oxides, lead oxides, strontium chromate, carbon black, coal dust, titanium dioxide, talc, barium sulfate, thermally conductive, electrically insulative filler materials, thermally conductive, electrically conductive filler materials, non-thermally conductive, electrically insulative filler materials, fire-retardant pigments, as well as color pigments such as cadmium yellow, cadmium red, chromium yellow and the like. As used herein, “electrically insulative filler” refers to a pigment, filler, or inorganic powder that has a volume resistivity of at least 10 Ω·m (measured according to ASTM D257, C611, or B193). As used herein, “electrically conductive filler” refers to a pigment, filler, or inorganic powder that has a volume resistivity of less than 10 Ω·m (measured according to ASTM D257, C611, or B193). As used herein, “thermally conductive filler” refers to a pigment, filler, or inorganic powder that has a thermal conductivity of at least 5 W/m·K at 25° C. (measured according to ASTM D7984). As used herein, “non-thermally conductive filler” refers to a pigment, filler, or inorganic powder that has a thermal conductivity of less than 5 W/m·K at 25° C. (measured according to ASTM D7984).

The pigment may comprise a plate-like pigment, such as an inorganic plate-like pigment.

The plate-like pigment may be a phyllosilicate pigment. As used herein, the term “phyllosilicate” refers to a group of minerals having sheets of silicates having a basic structure based on interconnected six membered rings of SiO₄⁻⁴ tetrahedra that extend outward in infinite sheets where 3 out of the 4 oxygens from each tetrahedra are shared with other tetrahedra resulting in phyllosilicates having the basic structural unit of Si₂O₅⁻². Phyllosilicates may comprise hydroxide ions located at the center of the tetrahedra and/or cations such as, for example, Fe⁺², Mg⁺², or Al⁺³, that form cation layers between the silicate sheets where the cations may coordinate with the oxygen of the silicate layer and/or the hydroxide ions. The term “phyllosilicate pigment” refers to pigment materials comprising phyllosilicates. Non-limiting examples of phyllosilicate pigments include the micas, chlorites, serpentine, talc, and the clay minerals. The clay minerals include, for example, kaolin clay. The sheet-like structure of the phyllosilicate pigment tends to result in pigment having a plate-like structure, although the pigment can be manipulated (such as through mechanical means) to have other particle structures. These pigments, when exposed to liquid media, may or may not swell and may or may not have leachable components (e.g.: ions that may be drawn towards the liquid media).

The plate-like pigment may comprise a plate-like mica pigment, a plate-like chlorite pigment, a plate-like serpentine pigment, a plate-like talc pigment, and/or a plate-like clay pigment. The plate-like clay pigment may comprise, consist essentially of, or consist of kaolin clay.

The pigment component comprising a plate-like pigment may have an average equivalent spherical diameter of at least 50 nm and up to 25 microns or higher. The average equivalent spherical diameter may be determined using dynamic light scattering, such as with a SEDIGRAPH III PLUS particle size analyzer, available from Micromeritics Instrument Corp. As plate-like particles the pigment often has substantially opposing surfaces and particles typically exhibit an aspect ratio of the longest axis to the shortest axis of, for example, at least 2:1, such as at least 4:1, such as at least 6:1, such as at least 8:1, such as at least 10:1 or higher. For example, the plate-like pigment may have an average equivalent spherical diameter of at least 50 nm, such as at least 0.2 microns, such as at least 0.4 microns, such as at least 0.6 microns, such as at least 1 micron, such as at least 2 microns, such as at least 3 microns, such as at least 4 microns, such as at least 5 microns. The plate-like pigment may have an average equivalent spherical diameter of no more than 25 microns, such as no more than 15 microns, such as no more than 10 microns, such as no more than 5 microns, such as no more than 3.5 microns, such as no more than 2.5 microns, such as no more than 1.9 microns, such as no more than 1.5 microns, such as no more than 1 microns.

The pigment-to-binder (P:B) ratio as set forth in this disclosure may refer to the weight ratio of the pigment-to-binder in the electrodepositable coating composition. The pigment-to-binder (P:B) ratio of the pigment to the electrodepositable binder may be at least 0.05:1, such as at least 0.1:1, such as at least 0.2:1, such as at least 0.3:1, such as at least 0.35:1, such as at least 0.4:1, such as at least 0.5:1, such as at least 0.6:1, such as at least 0.67, such as at least 0.7:1, such as at least 0.75:1, such as at least 1:1, such as at least 1.25:1, such as at least 1.5:1. The pigment-to-binder (P:B) ratio of the pigment to the electrodepositable binder may be no more than 2:1, such as no more than 1.75:1, such no more than 1.5:1, such as no more than 1.25:1, such as no more than 1:1, such as no more than 0.75:1, such as no more than 0.7:1, such as no more than 0.6:1, such as no more than 0.55:1, such as no more than 0.5:1, such as no more than 0.25:1. The pigment-to-binder (P:B) ratio of the pigment to the electrodepositable binder may be 0.05:1 to 2:1, such as 0.05:1 to 1:1, such as 0.05:1 to 0.75:1, such as 0.05:1 to 0.7:1, such as 0.05:1 to 0.6:1, such as 0.05:1 to 0.55:1, such as 0.05:1 to 0.5:1, such as 0.05 to 0.25:1, such as 0.1:1 to 2:1, such as 0.1:1 to 1:1, such as 0.1:1 to 0.75:1, such as 0.1:1 to 0.7:1, such as 0.1:1 to 0.6:1, such as 0.1:1 to 0.55:1, such as 0.1:1 to 0.5:1, such as 0.1:1 to 0.25:1, such as 0.2:1 to 2:1, such as 0.2:1 to 1:1, such as 0.2:1 to 0.75:1, such as 0.2:1 to 0.7:1, such as 0.2:1 to 0.6:1, such as 0.2:1 to 0.55:1, such as 0.2:1 to 0.5:1, such as 0.2:1 to 0.25:1, such as 0.3:1 to 2:1, 0.3:1 to 1:1, such as 0.3:1 to 0.75:1, such as 0.3:1 to 0.7:1, such as 0.3:1 to 0.6:1, such as 0.3:1 to 0.55:1, such as 0.3:1 to 0.5:1, such as 0.4:1 to 2:1, such as 0.4:1 to 1.75:1, such as 0.4:1 to 1.5:1, such as 0.4:1 to 1.25:1, such as 0.4:1 to 1:1, such as 0.4:1 to 0.75:1, such as 0.4:1 to 0.7:1, such as 0.4:1 to 0.6:1, such as 0.4:1 to 0.55:1, such as 0.4:1 to 0.5:1, such as 0.5:1 to 2:1, such as 0.5:1 to 1.75:1, such as 0.5:1 to 1.50:1, such as 0.5:1 to 1.25:1, such as 0.5:1 to 1:1, such as 0.5:1 to 0.75:1, such as 0.5:1 to 0.7:1, such as 0.5:1 to 0.6:1, such as 0.5:1 to 0.55:1, such as 0.6:1 to 2:1, such as 0.6:1 to 1.75:1, such as 0.6:1 to 1.5:1, such as 0.6:1 to 1.25:1, such as 0.6:1 to 1:1, such as 0.6:1 to 0.75:1, such as 0.6:1 to 0.7:1, such as 0.67:1 to 2:1, such as 0.67:1 to 1.75:1, such as 0.67:1 to 1.5:1, such as 0.67:1 to 1.25:1, such as 0.67:1 to 1:1, such as 0.67:1 to 0.75:1, such as 0.67:1 to 0.7:1, such as 0.7:1 to 2:1, such as 0.7:1 to 1.75:1, such as 0.7:1 to 1.5:1, such as 0.7:1 to 1.25:1, such as 0.7:1 to 1:1, such as 0.7:1 to 0.75:1, such as 0.75:1 to 2:1, such as 0.75:1 to 1.75:1, such as 0.75:1 to 1.5:1, such as 0.75:1 to 1.25:1, such as 0.75:1 to 1:1, such as 1:1 to 2:1, such as 1:1 to 1.75:1, such as 1:1 to 1.5:1, such as 1:1 to 1.25:1, such as 1.25:1 to 2:1, such as 1.25:1 to 1.75:1, such as 1.25:1 to 1.5:1, such as 1.5:1 to 2:1, such as 1.5:1 to 1.75:1.

The pigment-to-binder (P:B) ratio of the inorganic plate-like pigment to the electrodepositable binder may be at least 0.4:1, such as at least 0.5:1, such as at least 0.6:1, such as at least 0.75:1, such as at least 1:1, such as at least 1.25:1, such as at least 1.5:1. The pigment-to-binder (P:B) ratio of the inorganic plate-like pigment to the electrodepositable binder may be no more than 2:1, such as no more than 1.75:1, such no more than 1.5:1, such as no more than 1.25:1, such as no more than 1:1, such as no more than 0.75:1, such as no more than 0.7:1, such as no more than 0.6:1, such as no more than 0.55:1, such as no more than 0.5:1. The pigment-to-binder (P:B) ratio of the inorganic plate-like pigment to the clectrodepositable binder may be 0.4:1 to 2:1, such as 0.4:1 to 1.75:1, such as 0.4:1 to 1.5:1, such as 0.4:1 to 1.25:1, such as 0.4:1 to 1:1, such as 0.4:1 to 0.75:1, such as 0.4:1 to 0.7:1, such as 0.4:1 to 0.6:1, such as 0.4:1 to 0.55:1, such as 0.4:1 to 0.5:1, such as 0.5:1 to 2:1, such as 0.5:1 to 1.75:1, such as 0.5:1 to 1.50:1, such as 0.5:1 to 1.25:1, such as 0.5:1 to 1:1, such as 0.5:1 to 0.75:1, such as 0.5:1 to 0.7:1, such as 0.5:1 to 0.6:1, such as 0.5:1 to 0.55:1, such as 0.6:1 to 2:1, such as 0.6:1 to 1.75:1, such as 0.6:1 to 1.5:1, such as 0.6:1 to 1.25:1, such as 0.6:1 to 1:1, such as 0.6:1 to 0.75:1, such as 0.6:1 to 0.7:1, such as 0.75:1 to 2:1, such as 0.75:1 to 1.75:1, such as 0.75:1 to 1.5:1, such as 0.75:1 to 1.25:1, such as 0.75:1 to 1:1, such as 1:1 to 2:1, such as 1:1 to 1.75:1, such as 1:1 to 1.5:1, such as 1:1 to 1.25:1, such as 1.25:1 to 2:1, such as 1.25:1 to 1.75:1, such as 1.25:1 to 1.5:1, such as 1.5:1 to 2:1, such as 1.5:1 to 1.75:1.

The electrodepositable coating composition may optionally comprise a dispersing agent to assist in dispersing the pigment and other optional filler materials.

The electrodepositable coating and/or electrodepositable compositions may optionally comprise a corrosion inhibitor. Any suitable corrosion inhibitor may be used. For example, the corrosion inhibitor may comprise a corrosion inhibitor comprising yttrium, lanthanum, cerium, calcium, an azole, or any combination thereof.

Non-limiting examples of suitable azoles include benzotriazole, 5-methyl benzotriazole, 2-amino thiazole, as well as salts thereof.

The corrosion inhibitor(s) may be present, if at all, in the electrodepositable coating composition in an amount of at least 0.001% by weight, such as at least 5% by weight, based on the total weight of the electrodepositable coating composition. The corrosion inhibitor(s) may be present, if at all, in the electrodepositable coating composition in an amount of no more than 25% by weight, such as no more than 15% by weight, such as no more than 10% by weight, based on the total weight of the electrodepositable coating composition. The corrosion inhibitor(s) may be present, if at all, in the electrodepositable coating composition in an amount of 0.001% to 25% by weight based on total weight of the electrodepositable coating composition, such as 0.001% to 15% by weight, such as 0.001% to 10% by weight, such as 5% to 25% by weight, such as 5% to 15% by weight, such as 5% to 10% by weight.

Alternatively, the electrodepositable coating composition may be substantially free, essentially free, or completely free of a corrosion inhibitor.

According to the present disclosure, the electrodepositable coating composition may comprise other optional ingredients, such as various additives including fillers, plasticizers, antioxidants, biocides, UV light absorbers and stabilizers, hindered amine light stabilizers, defoamers, fungicides, dispersing aids, flow control agents, surfactants, wetting agents, or combinations thereof. Alternatively, the electrodepositable coating composition may be completely free of any of the optional ingredients, i.e., the optional ingredient is not present in the electrodepositable coating composition. The other additives mentioned above may be present in the electrodepositable coating composition in amounts of 0.01% to 3% by weight, based on total weight of the resin solids of the electrodepositable coating composition, either cumulatively or respectively.

According to the present disclosure, the electrodepositable coating composition may comprise water and/or one or more organic solvent(s). Water can, for example, be present in amounts of 40% to 90% by weight, such as 50% to 75% by weight, based on total weight of the electrodepositable coating composition. Examples of suitable organic solvents include oxygenated organic solvents, such as monoalkyl ethers of ethylene glycol, diethylene glycol, propylene glycol, and dipropylene glycol which contain from 1 to 10 carbon atoms in the alkyl group, such as the monoethyl and monobutyl ethers of these glycols. Examples of other at least partially water-miscible solvents include alcohols such as ethanol, isopropanol, butanol and diacetone alcohol. If used, the organic solvents may typically be present in an amount of less than 10% by weight, such as less than 5% by weight, based on total weight of the electrodepositable coating composition. The electrodepositable coating composition may, in particular, be provided in the form of a dispersion, such as an aqueous dispersion.

According to the present disclosure, the total solids content of the electrodepositable coating composition may be at least 1% by weight, such as at least 5% by weight, and may be no more than 50% by weight, such as no more than 40% by weight, such as no more than 20% by weight, based on the total weight of the electrodepositable coating composition. The total solids content of the electrodepositable coating composition may be 1% to 50% by weight, such as 5% to 40% by weight, such as 5% to 20% by weight, based on the total weight of the electrodepositable coating composition. As used herein, “total solids” refers to the non-volatile content of the electrodepositable coating composition, i.e., materials which will not volatilize when heated to 110° C. for 15 minutes.

The electrodepositable coating composition may be electrophoretically applied to the electroconductive substrate and at least partially cured using application conditions, times, and temperatures, as known to those skilled in the art.

The cationic electrodepositable coating composition of the present disclosure may be deposited upon an electrically conductive substrate by placing the composition in contact with an electrically conductive cathode and an electrically conductive anode, with the surface to be coated being the cathode. Following contact with the composition, an adherent coating of the coating composition may be deposited on the cathode when a sufficient voltage is impressed between the electrodes.

The anionic electrodepositable coating composition of the present disclosure may be deposited upon an electrically conductive substrate by placing the composition in contact with an electrically conductive cathode and an electrically conductive anode, with the surface to be coated being the anode. Following contact with the composition, an adherent coating of the coating composition may be deposited on the anode when a sufficient voltage is impressed between the electrodes.

The applied voltage in the electrophoretic application of the electrodepositable coating compositions of the present disclosure may be varied and may be, for example, as low as one volt to as high as several thousand volts, such as between 50 and 500 volts. The current density may, for example, be between 0.5 ampere and 15 amperes per square foot and tends to decrease during electrodeposition indicating the formation of an insulating coating.

### Pre-Spray Composition

As previously stated, the system for treating a substrate may comprise a pre-spray composition. The pre-spray composition may comprise, consist essentially of, or consist of a surfactant and a binder and optionally water.

The surfactant may be any of the surfactants disclosed herein above. The surfactant may be present in the pre-spray composition in an amount of at least 50 ppm based on total weight of the pre-spray composition, such as at least 100 ppm, such as at least 200 ppm, such as at least 500 ppm. The surfactant may be present in the pre-spray composition in an amount of no more than 20,000 ppm based on total weight of the pre-spray composition, such as no more than 10,000 ppm, such as no more than 7,500 ppm, such as no more than 5,000 ppm. The surfactant may be present in the pre-spray composition in an amount of 50 ppm to 20,000 ppm based on total weight of the pre-spray composition, such as 100 ppm to 10,000 ppm, such as 200 ppm to 7,500 ppm, such as 500 ppm to 5,000 ppm.

The builder may inhibit or reduce flash rusting. The builder may comprise any of the builders disclosed herein above. The builder may optionally comprise sodium tripolyphosphate.

The builder may be present in the pre-spray composition in an amount of at least 5 ppm based on total weight of the pre-spray composition, such as at least 10 ppm, such as at least 50 ppm. The builder may be present in the pre-spray composition in an amount of no more than 2,000 ppm based on total weight of the pre-spray composition, such as no more than 1,500 ppm, such as no more than 1,000 ppm. The builder may be present in the pre-spray composition in an amount of 5 ppm to 5,000 ppm based on total weight of the pre-spray composition, such as 20 ppm to 2,000 ppm, such as 50 ppm to 1,000 ppm.

The pre-spray composition may have a pH of at least 1, such as at least 2, such as at least 2.5, such as at least 5. The pre-spray composition may have a pH of no more than 8.5, such as no more than 8, such as no more than 7.5. The pre-spray composition may have a pH of 1 to 8.5, such as 2 to 8, such as 2.5 to 7.5, such as 5 to 7.5.

The pre-spray composition may be substantially free, essentially free, or completely free of phosphate and/or chromium, details of which are set forth herein above.

The pre-spray composition may comprise an aqueous medium, an organic medium, or combinations thereof. Examples of organic mediums include but are not limited to glycol ether and/or a high flash hydrocarbon solvent.

In examples, the solution or dispersion of the pre-spray composition may be applied or contacted to the substrate surface by any conventional means known in the art. For example, the solution or dispersion may be brought into contact with the substrate by any of a variety of known techniques, such as dipping or immersion, spraying, intermittent spraying, dipping followed by spraying, spraying followed by dipping, brushing, or roll-coating. The solution or dispersion, when applied to the metal substrate, may be at a temperature ranging from 10° C. to 90° C., such as 25° C. to 75° C. For example, the process may be carried out at ambient or room temperature. The contact time is often from 5 seconds to 5 minutes, such as 10 seconds to 2 minutes.

### Methods

The present disclosure is further directed to a method for coating a substrate comprising applying any of the cleaner-coater compositions disclosed herein to at least a portion of a surface of the substrate.

The present disclosure is further directed to a method of treating a substrate comprising applying any of the cleaner-coater compositions disclosed herein and any of the electrodepositable coating compositions disclosed herein.

The substrate may be contacted with the cleaner-coater composition prior to being contacted with the electrodepositable coating composition.

The method may optionally further comprise a rinse step between application of the cleaner-coater composition and application of the electrodepositable coating composition. Alternatively, the method may exclude a rinse step between application of the cleaner-coater composition and application of the electrodepositable coating composition.

The method of treating a substrate may optionally further comprise treating the substrate with any of the pre-spray compositions disclosed herein. The method may exclude a rinse step between application of the pre-spray composition and application of the cleaner-coater composition.

The substrate may be contacted with the pre-spray composition prior to being contacted with the cleaner-coater composition. The substrate may be contacted with the cleaner-coater composition prior to being contacted with the electrodepositable coating composition.

The solution or dispersion of the cleaner-coater composition may be spontaneously applied or contacted to the substrate surface. For example, the solution or dispersion may be brought into contact with the substrate by any of a variety of known techniques, such as dipping or immersion, spraying, intermittent spraying, dipping followed by spraying, spraying followed by dipping, brushing, or roll-coating. The solution or dispersion, when applied to the metal substrate, may be at a temperature ranging from 20° C. to 50° C., such as 25° C. to 40° C. For example, the process may be carried out at ambient or room temperature. The contact time is often from 15 seconds to 5 minutes, such as 30 seconds to 4 minutes, such as 1 minute to 3 minutes. As used herein, “spontaneous” or “spontaneously,” when used with respect to a cleaner-coater composition, refers to a cleaner-coater composition that is capable of reacting with and chemically altering the substrate surface and binding to it to form a protective layer in the absence of an externally applied voltage.

Following application of the cleaner-coater composition to at least a portion of a surface of the substrate, the substrate optionally may be rinsed with tap water, deionized water, and/or an aqueous solution of rinsing agents to remove any residue. The wet substrate surface may be treated with one of the electrodepositable coating compositions described herein below or the substrate may be dried prior to further treating the substrate surface, such as air dried, for example, by using an air knife, by flashing off the water by brief exposure of the substrate to a high temperature, such as 15° C. to 100° C., such as 20° C. to 90° C., or in a heater assembly using, for example, infrared heat, such as for 10 minutes at 70° C., or by passing the substrate between squeegee rolls.

Following application of the electrodepositable coating composition, the substrate may be heated to a temperature and for a time sufficient to at least partially cure the electrodeposited coating on the substrate. As used herein, the term “at least partially cure” refers to subjecting the coating composition to curing conditions such that at least a portion of the reactive groups of the components of the coating composition cure or crosslink to form a coating. In general, the substrate may be heated to a temperature ranging from 250° F. to 450° F. (121.1° C. to 232.2° C.), such as from 275° F. to 400° F. (135° C. to 204.4° C.), such as from 300° F. to 360° F. (149° C. to 180° C.). For purposes of the present disclosure, all that is necessary is that the time be sufficient to effect cure of the coating on the substrate. The curing time may, for example, range from 10 minutes to 60 minutes, such as 20 to 40 minutes. The thickness of the resultant cured electrodeposited coating is not limited and may optionally range from 15 to 50 microns.

The method may optionally exclude application of an additional cleaning composition that is not any of the compositions disclosed herein.

### Substrates

The present disclosure is also directed to a substrate that has been treated by one of the cleaner-coater compositions, systems, and/or methods disclosed herein.

Suitable substrates that may be used include metal substrates, metal alloy substrates, and/or substrates that have been metallized, such as nickel-plated plastic. The metal or metal alloy can comprise or be steel, aluminum, zinc, nickel, and/or magnesium. For example, the steel substrate could be cold rolled steel, hot rolled steel, electrogalvanized steel, and/or hot dipped galvanized steel. Aluminum alloys of the 1XXX, 2XXX, 3XXX, 4XXX, 5XXX, 6XXX, or 7XXX series as well as clad aluminum alloys also may be used as the substrate. Aluminum alloys may comprise, for example, 0.01% by weight copper to 10% by weight copper. Aluminum alloys which are treated may also include castings, such as 1XX.X, 2XX.X, 3XX.X, 4XX.X, 5XX.X, 6XX.X, 7XX.X, 8XX.X, or 9XX.X (e.g., A356.0). Magnesium alloys of the AZXX (including Eform Plus), AMXX, EVXX, ZEXX, ZCXX, HKXX, HZXX, QEXX, QHXX, WEXX, ZEK100, or Elektron 21 series also may be used as the substrate. The substrate used may also comprise titanium and/or titanium alloys, zinc and/or zinc alloys, and/or nickel and/or nickel alloys. Suitable substrates for use in the present disclosure include those that are often used in the assembly of vehicular bodies (e.g., without limitation, door, body panel, trunk deck lid, roof panel, hood, roof and/or stringers, rivets, landing gear components, and/or skins used on an aircraft), a vehicular frame, vehicular parts, motorcycles, wheels, industrial structures and components such as appliances, including washers, dryers, refrigerators, stoves, dishwashers, and the like, personal electronics, agricultural equipment, lawn and garden equipment, metal fencing, guard rails, air conditioning units, heat pump units, heat exchangers, lawn furniture, and other articles. As used herein, “vehicle” or variations thereof includes, but is not limited to, civilian, commercial and military aircraft, and/or land vehicles such as cars, motorcycles, trucks, and/or bicycles including electric bicycles. The metal substrate also may be in the form of, for example, a sheet of metal or a fabricated part.

In examples, the substrate may be a multi-metal article. As used herein, the term “multi-metal article” refers to (1) an article that has at least one surface comprised of a first metal and at least one surface comprised of a second metal that is different from the first metal, (2) a first article that has at least one surface comprised of a first metal and a second article that has at least one surface comprised of a second metal that is different from the first metal, or (3) both (1) and (2).

In examples, the substrate may comprise a battery or battery component. The battery component may comprise, but is not limited thereto, a battery cell, a battery shell, a battery module, a battery pack, a battery box, a battery cell casing, a pack shell, a battery lid and tray, a thermal management system, a battery housing, a module housing, a module racking, a battery side plate, a battery cell enclosure, a cooling module, a cooling tube, a cooling fin, a cooling plate, a bus bar, a battery frame, an electrical connection, metal wires, or copper or aluminum conductors or cables. The battery may be, for example, an electric vehicle battery, and the battery component may be, for example, an electric vehicle battery component.

In examples, the substrate may comprise a three-dimensional component formed by an additive manufacturing process such as selective laser melting, e-beam melting, directed energy deposition, binder jetting, metal extrusion, and the like. In examples, the three-dimensional component may be a metal and/or resinous component.

The substrate may comprise a coating on at least a portion of the substrate surface. A coating may be formed from any of the cleaner-coater compositions disclosed herein. A coating may be formed from any of the electrodepositable coating compositions disclosed herein. A substrate may comprise a first coating on at least a portion of the substrate surface formed from one of the cleaner-coater compositions disclosed herein and a second coating on at least a portion of the substrate surface formed from one of the electrodepositable coating compositions disclosed herein.

Additional coating layers may be added to the substrate, including any suitable additional coating layers known in the art, and each may independently be waterborne, solventborne, in solid particulate form (i.e., a powder coating composition), or in the form of a powder slurry. The additional coating layers may each be cured independently, or optionally applied “wet-on-wet” and cured simultaneously. As used herein, “wet-on-wet” refers to a process, wherein a coating, for example a clear coat, is applied over a substantially uncured different coating, for example a color coat, and both coatings are then cured simultaneously.

The weight ratio of the Group IVB metal and the electropositive metal in the coating formed from one of the cleaner-coater compositions disclosed herein may be at least 1:10, such as at least 3:22, such as at least 1:6. The weight ratio of the Group IVB metal and the electropositive metal in the coating formed from one of the cleaner-coater compositions disclosed herein may be no more than 2:1, such as no more than 1:1, such as no more than 1:2. The weight ratio of the Group IVB metal and the electropositive metal in the coating formed from one of the cleaner-coater compositions disclosed herein may be 1:10 to 1:2, such as 3:22 to 1:1, such as 1:6 to 1:2.

The coating formed from the cleaner-coater composition may comprise the Group IVB metal in an amount of less than 50 mg/m², as measured by ICP-OES, such as 3 mg/m² to 20 mg/m².

The coating formed from the cleaner-coater composition may comprise the electropositive metal in an amount of at least 5 mg/m², as measured by ICP-OES.

It has been surprisingly discovered that a substrate treated with one of the cleaner-coater compositions disclosed herein demonstrates a lower Group IVB coating weight and improved corrosion performance compared to a substrate treated with a conventional cleaning composition and a conventional pretreatment composition. Thus, the cleaner-coater compositions disclosed herein surprisingly provide increased corrosion performance using fewer treatment steps. It has also been surprisingly discovered that a substrate treated with one of the pre-spray compositions disclosed herein and one of the cleaner-coater compositions disclosed herein maintains corrosion performance compared to a substrate treated with a conventional cleaning composition and conventional pretreatment composition, while allowing for elimination of a rinse step between application of the compositions.

### Aspects

1. A cleaner-coater composition comprising:
a Group IVB metal in an amount of 50 ppm to 8,000 ppm based on total weight of the cleaner-coater composition;
an electropositive metal such as copper;
a builder comprising a phosphonate and/or a sugar alcohol; and
a surfactant in an amount of 50 ppm to 20,000 ppm based on total weight of the cleaner-coater composition.

2. The cleaner-coater composition of aspect 1, wherein the Group IVB metal comprises zirconium, titanium, or a combination thereof, and wherein the Group IVB metal optionally is provided by hexafluorozirconic acid, hexafluorotitanic acid, salts of either of the foregoing, or a combination of any of the foregoing.

3. The cleaner-coater composition of aspect 1 or aspect 2, comprising the Group IVB metal in an amount of:
(a) at least 100 ppm, such as at least 150 ppm, such as at least 200 ppm, such as at least 500 ppm, such as at least 600 ppm, such as at least 700 ppm, such as at least 800 ppm, such as at least 900 ppm based on total weight of the cleaner-coater composition;
(b) no more than 6,000 ppm, such as no more than 5,000 ppm, such as no more than 4,000 ppm, such as no more than 3,000 ppm, such as no more than 2,000 ppm, such as no more than 1,500 ppm based on total weight of the cleaner-coater composition; and/or
(c) 100 ppm to 6,000 ppm, such as 150 ppm to 4,000 ppm, such as 200 ppm to 2,000 ppm, such as 500 ppm to 5,000 ppm, such as 500 ppm to 1,500 ppm, such as 600 ppm to 4,000 ppm, such as 700 ppm to 3,000 ppm, such as 800 ppm to 2,000 ppm, such as 900 ppm to 1,500 ppm based on total weight of the cleaner-coater composition.

4. The cleaner-coater composition of any of the preceding aspects, comprising the electropositive metal in an amount of:
(a) at least 2 ppm, such as at least 10 ppm, such as at least 20 ppm based on total weight of the cleaner-coater composition;
(b) no more than 200 ppm, such as no more than 100 ppm, such as no more than 75 ppm, such as no more than 40 ppm based on total weight of the cleaner-coater composition; and/or
(c) 2 ppm to 200 ppm, such as 2 ppm to 75 ppm, such as 10 ppm to 200 ppm, such as 20 ppm to 40 ppm based on total weight of the cleaner-coater composition.

5. The cleaner-coater composition of any of the preceding aspects, wherein the phosphonate comprises a monophosphonate, a diphosphonate such as etidronic acid, and/or a polyphosphonate, and/or wherein the sugar alcohol comprises sorbitol.

6. The system of any of the preceding aspects, wherein the builder comprises a flash rust inhibitor.

7. The cleaner-coater composition of any of the preceding aspects, comprising the builder in an amount of:
(a) at least 10 ppm, such as at least 30 ppm, such as at least 50 ppm based on total weight of the cleaner-coater composition;
(b) no more than 2,500 ppm, such as no more than 2,000 ppm, such as no more than 1,500 ppm based on total weight of the cleaner-coater composition; and/or
(c) 10 ppm to 2,500 ppm, such as 30 ppm to 2,000 ppm, such as 50 ppm to 1,500 ppm based on total weight of the cleaner-coater composition.

8. The system of any of the preceding aspects, wherein the surfactant comprises a cationic surfactant, an anionic surfactant, a nonionic surfactant, and/or an amphoteric surfactant.

9. The cleaner-coater composition of any of the preceding aspects, comprising the surfactant in an amount of:
(a) at least 100 ppm, such as at least 200 ppm, such as at least 500 ppm based on total weight of the cleaner-coater composition;
(b) no more than 10,000 ppm, such as no more than 7,500 ppm, such as no more than 5,000 ppm based on total weight of the cleaner-coater composition; and/or
(c) 100 ppm to 10,000 ppm, such as 200 ppm to 7,500 ppm, such as 500 ppm to 5,000 ppm based on total weight of the cleaner-coater composition.

10. The cleaner-coater composition of any of the preceding aspects, wherein the cleaner-coater composition is substantially free, or essentially free, or completely free, of phosphates and/or sodium nitrobenzene sulfonate.

11. The cleaner-coater composition of any of the preceding aspects, further comprising:
(a) an aqueous medium;
(b) total fluoride, optionally in an amount of:
   (i) at least 60 ppm, such as at least 125 ppm, such as at least 200 ppm, such as at least 250 ppm based on total weight of the cleaner-coater composition;
   (ii) no more than 10,000 ppm, such as no more than 7,500 ppm, such as no more than 5,000 ppm, such as no more than 3,000 ppm, such as no more than 2,500 ppm based on total weight of the cleaner-coater composition; and/or
   (iii) 60 ppm to 10,000 ppm, such as 125 ppm to 7,500 ppm, such as 200 ppm to 5,000 ppm, such as 250 ppm to 2,500 ppm based on total weight of the cleaner-coater composition; and/or
(c) free fluoride, optionally in an amount of:
   (i) at least 25 ppm, such as at least 35 ppm, such as at least 50 ppm based on total weight of the cleaner-coater composition;
   (ii) no more than 750 ppm, such as no more than 600 ppm, such as no more than 500 ppm based on total weight of the cleaner-coater composition; and/or
   (iii) 25 ppm to 750 ppm, such as 35 ppm to 600 ppm, such as 50 ppm to 500 ppm based on total weight of the cleaner-coater composition.

12. A system for treating a substrate comprising:
the cleaner-coater composition of any of the preceding aspects; and
an electrodepositable coating composition for coating at least in part the portion of the surface of the substrate treated with the cleaner-coater composition.

13. A system for treating a substrate comprising:
a cleaner-coater composition comprising: a Group IVB metal in an amount of 50 ppm to 8,000 ppm based on total weight of the cleaner-coater composition; an electropositive metal such as copper; and a surfactant in an amount of 50 ppm to 20,000 ppm based on total weight of the cleaner-coater composition; and
an electrodepositable coating composition for coating at least in part the portion of the surface of the substrate treated with the cleaner-coater composition.

14. The system of aspect 12 or aspect 13, wherein electrodepositable coating composition comprises an electrodepositable binder comprising an active hydrogen-containing, ionic salt group-containing film-forming polymer, a curing agent, and a plate-like pigment.

15. The system of aspect 14, wherein the electrodepositable coating composition comprises the plate-like pigment in a pigment-to-binder ratio of at least 0.4:1, such as at least 0.5:1, such as at least 0.6:1, such as at least 0.75:1, such as at least 1:1, such as at least 1.25:1, such as at least 1.5:1.

16. The system of aspect 14 or aspect 15, wherein the plate-like pigment comprises an average equivalent spherical diameter of at least:
(a) at least 50 nm, such as at least 0.2 microns, such as at least 0.4 microns, such as at least 0.6 microns, such as at least 1 micron, such as at least 2 microns, such as at least 3 microns, such as at least 4 microns, such as at least 5 microns as measured by dynamic light scattering;
(b) no more than 25 microns, such as no more than 15 microns, such as no more than 10 microns, such as no more than 5 microns, such as no more than 3.5 microns, such as no more than 2.5 microns, such as no more than 1.9 microns, such as no more than 1.5 microns, such as no more than 1 micron as measured by dynamic light scattering; and/or
(c) 50 nm to 25 microns, such as 0.2 microns to 15 microns, such as 0.4 to 10 microns, such as 0.6 microns to 5 microns, such as 1 micron to 3.5 microns, such as 2 microns to 15 microns, such as 3 microns to 10 microns, such as 4 microns to 25 microns, such as 5 microns to 25 microns, such as 50 nm to 2.5 microns, such as 0.2 microns to 1.9 microns, such as 0.4 microns to 1.5 microns, such as 50 nm to 1 micron as measured by dynamic light scattering.

17. The system of any of aspects 14 to 16, wherein the plate-like pigment comprises a phyllosilicate pigment such as mica, chlorite, serpentine, talc, a clay such as kaolin clay, or combinations thereof.

18. The system of any of aspects 12 to 17, wherein the electrodepositable coating composition comprises a film-forming polymer comprising a blocked polyisocyanate, an aminoplast, a phenoplast, or combinations thereof.

19. The system of any of aspects 12 to 18, wherein the system excludes a separate cleaning step.

20. The system of any of aspects 12 to 19, further comprising a pre-spray composition comprising a surfactant in an amount of 50 ppm to 20,000 ppm based on total weight of the pre-spray composition.

21. The system of aspect 20, wherein the surfactant comprises a cationic surfactant, an anionic surfactant, a nonionic surfactant, an amphoteric surfactant, or a combination thereof.

22. The system of aspect 20 or aspect 21, wherein the pre-spray composition comprises the surfactant in an amount of:
(a) at least 50 ppm, such as at least 100 ppm, such as at least 200 ppm, such as at least 500 ppm based on total weight of the pre-spray composition;
(b) no more than 20,000 ppm, such as no more than 10,000 ppm, such as no more than 7,500 ppm, such as no more than 5,000 ppm based on total weight of the pre-spray composition; and/or
(c) 50 ppm to 20,000 ppm, such as 100 ppm to 10,000 ppm, such as 200 ppm to 7,500 ppm, such as 500 ppm to 5,000 ppm based on total weight of the pre-spray composition.

23. The system of any of aspects 20 to 22, wherein the pre-spray composition further comprises a builder.

24. The system of aspect 23, wherein the builder comprises a phosphonate such as a monophosphonate, a diphosphonate such as etidronic acid, and/or a polyphosphonate, and/or wherein the builder comprises a sugar alcohol such as sorbitol.

25. The system of aspect 23 or aspect 24, wherein the pre-spray composition comprises the builder in an amount of:
(a) at least 5 ppm, such as at least 10 ppm, such as at least 50 ppm based on total weight of the pre-spray composition;
(b) no more than 2,000 ppm, such as no more than 1,500 ppm, such as no more than 1,000 ppm based on total weight of the pre-spray composition; and/or
(c) 5 ppm to 5,000 ppm, such as 20 ppm to 2,000 ppm, such as 50 ppm to 1,000 ppm based on total weight of the pre-spray composition.

26. The system of any of aspects 20 to 22, wherein the pre-spray composition is substantially free, or essentially free, or completely free, of a builder.

27. The system of any of aspects 20 to 26, wherein the system excludes a rinse step.

28. A method of coating a substrate comprising applying the composition of any of aspects 1 to 11 to a portion of a surface of the substrate.

29. A method of coating a substrate comprising:
applying the cleaner-coater composition of any of aspects 12 to 27 to a portion of a surface of the substrate; and
applying the electrodepositable coating composition of any of aspects 12 to 27 to at least a portion of the surface of the substrate to which the cleaner-coater composition is applied.

30. The method of aspects 29, wherein the method excludes a separate cleaning step.

31. The method of any of aspects 28 to 30, further comprising applying the pre-spray composition of any of aspects 20 to 27 to the surface of the substrate.

32. The method of aspect 31, wherein the pre-spray is applied prior to the cleaner-coater composition.

33. The method of aspect 31 or aspect 32, wherein the method excludes a rinse step.

34. A substrate treated by the cleaner-coater composition of any of aspects 1 to 11.

35. A substrate treated by the system of any of any of aspects 12 to 27.

36. A substrate treated according to the method of any of aspects 28 to 33.

37. The substrate of any of aspects 34 to 36, comprising a coating formed on at least a portion of a surface of the substrate by application of the cleaner-coater composition thereon.

38. The substrate of aspect 37, wherein the coating comprises the Group IVB metal and/or the electropositive metal.

39. The substrate of any of aspects 34 to 38, wherein the coating comprises:
(a) the Group IVB metal and the electropositive metal in a weight ratio of:
   (i) at least 1:10, such as at least 3:22, such as at least 1:6;
   (ii) no more than 2:1, such as no more than 1:1, such as no more than 1:2; and/or
   (iii) 1:10 to 2:1, such as 3:22 to 1:1, such as 1:6 to 1:2;
(b) the Group IVB metal in an amount of less than 50 mg/m² as measured by ICP-OES; and/or
(c) the electropositive metal in an amount of less than 5 mg/m² as measured by ICP-OES.

40. The substrate of any of aspects 34 to 39, further comprising a second coating formed on at least a portion of the coating formed from the cleaner-coater composition by application of the electrodepositable coating composition thereon.

41. The substrate of any of aspects 34 to 40, wherein the substrate comprises an article, a part, or a combination thereof.

42. The substrate of aspect 41, wherein the article comprises a vehicle, an appliance, a personal electronic device, a circuit board, a battery cell, a multi-metal substrate, or a combination thereof.

43. The substrate of aspect 41, wherein the part comprises a vehicular part.

44. The substrate of aspect 42, wherein the vehicle comprises a land vehicle or an aircraft.

45. The substrate of any of aspects 37 to 44, further comprising a second coating formed by application of an electrodepositable coating composition to at least a portion of the surface of the substrate comprising the first coating.

46. A use of a coating formed from the cleaner-coater composition of any of aspects 1 to 11 to provide a coating comprising:
(a) the Group IVB metal and the electropositive metal in a weight ratio of:
   (i) at least 1:10, such as at least 3:22, such as at least 1:6;
   (ii) no more than 2:1, such as no more than 1:1, such as no more than 1:2; and/or
   (iii) 1:10 to 2:1, such as 3:22 to 1:1, such as 1:6 to 1:2;
(b) the Group IVB metal in an amount of less than 50 mg/m² as measured by ICP-OES; and/or
(c) the electropositive metal in an amount of less than 5 mg/m² as measured by ICP-OES.

47. A use of a coating formed from the cleaner-coater composition of any of aspects 12 to 25 to provide a coating comprising:
(a) the Group IVB metal and the electropositive metal in a weight ratio of:
   (i) at least 1:10, such as at least 3:22, such as at least 1:6;
   (ii) no more than 2:1, such as no more than 1:1, such as no more than 1:2; and/or
   (iii) 1:10 to 2:1, such as 3:22 to 1:1, such as 1:6 to 1:2;
(b) the Group IVB metal in an amount of less than 50 mg/m² as measured by ICP-OES; and/or
(c) the electropositive metal in an amount of less than 5 mg/m² as measured by ICP-OES.

48. A substrate comprising a first coating on a least a portion of a surface thereof, the coating comprising:
(a) a Group IVB metal and an electropositive metal in a weight ratio of:
   (i) at least 1:10, such as at least 3:22, such as at least 1:6;
   (ii) no more than 2:1, such as no more than 1:1, such as no more than 1:2; and/or
   (iii) 1:10 to 2:1, such as 3:22 to 1:1, such as 1:6 to 1:2;
(b) a Group IVB metal in an amount of less than 50 mg/m² as measured by ICP-OES; and/or
(c) an electropositive metal in an amount of less than 5 mg/m² as measured by ICP-OES.

Whereas aspects of the disclosure have been described in detail, it will be appreciated by those skilled in the art that various modifications and alternatives to those details could be developed in light of the overall teachings of the disclosure. Accordingly, the particular arrangements disclosed are meant to be illustrative only and not limited as to the scope of the disclosure which is to be given the full breadth of the claims and aspects appended and any and all equivalents thereof.

### EXAMPLES

### Preparation of Compositions

Cleaners, pretreatments, and cleaner-coater compositions were prepared using additives and surfactants as described in this disclosure.

### Preparation of Alkaline Cleaner:

An alkaline cleaner solution (C1) was prepared in a rectangular stainless-steel tank equipped with spray nozzles using Chemkleen Surface Prep IR (CKSP1R) (an alkaline cleaner) and Chemkleen 185A (a blended surfactant additive), both available from PPG Industries, Inc.

### Preparation of Pre-Spray Composition:

Pre-spray composition (P-S): A rectangular stainless-steel tank with a total volume of 37 gallons, equipped with spray nozzles, was filled with 10 gallons of deionized water. To this was added Chemkleen 185A surfactant (38 mL), etidronic acid (2.88 g), 85% phosphoric acid (3 g), and sodium tripolyphosphate (25 g).

### Preparation of Pretreatment:

A pretreatment composition (PT1) was prepared by preparing Zircobond 1.5 (available from PPG Industries, Inc.) according to manufacturer's instructions.

### Preparation of Cleaner-Coaters:

Cleaner-Coater 1 (C-C1): To a clean five-gallon plastic bucket was added 18.85 liters of deionized water. Fluorozirconic acid (96.6 g), etidronic acid (4.8 g), 2% copper (II) nitrate solution (25 g), and Chemkleen 185A (19 mL) were then added. Etidronic acid (hydroxyl ethylidene (1, 1-diphosphonic acid)) was used as a 60 wt % in water solution, available as Dequest 2010 from Italmatch.

Cleaner-Coater 2 (C-C2): A rectangular stainless-steel tank with a total volume of 37 gallons, equipped with spray nozzles, was filled with 10 gallons of deionized water. To this was added fluorozirconic acid (193.2 g), etidronic acid (9.6 g), a 2% of copper from copper (II) nitrate solution (10 g), and Chemkleen 185A surfactant (38 mL).

C-C1 was circulated and maintained at 120° F. (50° C.) using an immersion heater (Polyscience Sous Vide Professional, Model #7306AC1B5, available from Polyscience, Niles, Illinois) and set to high agitation mode during immersion of panels to circulate and heat the composition contained therein.

After all the ingredients were added to C-C1 and C-C2, free fluoride was measured using a DualStar pH/ISE Dual Channel Benchtop Meter (available from ThermoFisher Scientific) equipped with a fluoride selective electrode (Orion ISE Fluoride Electrode, solid state, available from ThermoFisher Scientific) by immersing the ISE in the solution and allowing the measurement to equilibrate. The free fluoride was adjusted as needed with Chemfos AFL, a partially neutralized aqueous ammonium bifluoride solution, available from PPG Industries, Inc.

pH was measured using a pH meter (interface, DualStar pH/ISE Dual Channel Benchtop Meter, available from ThermoFisher Scientific, Waitham, MA, USA) and pH probe (Fisher Scientific ACCUMET pH probe (Ag/AgCl reference electrode)) by immersing the pH probe in the solution. pH of C-Cl and C-C2 were adjusted as needed to pH 4.5, while the pH of P-S was adjusted as needed to pH 7 with Chemfil Buffer, available from PPG Industries, Inc.

The amount of copper in each bath was measured using a DR/890 Colorimeter (available from HACH, Loveland, Colorado, USA) using an indicator (CuVer2 Copper Reagent Powder Pillows, available from HACH).

TABLE 1

| | | | | Free | Total | Total |
|---|---|---|---|---|---|---|
| | | | | fluoride | fluoride | additive |
| Code | Additive | Surfactant | pH | (ppm) | (ppm) | (ppm) |
| C-C1 | Cu(NO₃)₃ | Y | 4.5 | 154 | 1269 | 25 |
| C-C2 | Cu(NO₃)₃ | Y | 4.5 | 173 | 1264 | 5 |

### Preparation of Phosphate Acrylic Polyol:

Component 1 listed in Table 2, below, was added to a flask set up for total reflux with stirring under nitrogen and heated to 120° C. Components 9 and 10 (initiator charge 1) were added to the flask dropwise over 3 hours and 35 minutes. Five minutes after initiator charge 1 was started, components 2-8 (monomer charge) were mixed in an addition funnel and added dropwise over 3.5 hours. Once the monomer charge was complete, charge 13 was used to rinse the monomer charge addition funnel. After both charges were completed, the reaction was held at 120° C. for 1 hour. Components 11 and 12 (initiator charge 2) were then added dropwise via addition funnel to the reaction flask over 30 min. After initiator charge 2 was complete, Component 14 was used to rinse the addition funnel. The reaction was held for 90 minutes at 120° C., and then allowed to cool to room temperature with stirring. The resulting phosphate acrylic polyol resin had a solids content of 56% by weight.

TABLE 2

| | | Parts-by-weight |
|---|---|---|
| No. | Component | (grams) |
| 1 | Methyl isobutyl ketone | 688 |
| 2 | Isobornyl methacrylate¹ | 413 |
| 3 | Styrene² | 403 |
| 4 | 2-ethylhexyl acrylate³ | 165 |
| 5 | tert-dodecyl mercaptan⁴ | 9.90 |
| 6 | Sipomer ® PAM-200⁵ | 82.5 |
| 7 | 2-hydroxyethyl acrylate⁶ | 247.5 |
| 8 | Tone ™ M-201⁷ | 330 |
| 9 | tert-amyl peroxy-2-ethylhexanoate⁸ | 49.5 |
| 10 | Methyl isobutyl ketone | 376 |
| 11 | tert-amyl peroxy-2-ethylhexanoate⁸ | 5.00 |
| 12 | Methyl isobutyl ketone | 87.1 |
| 13 | Methyl isobutyl ketone | 45.8 |
| 14 | Methyl isobutyl ketone | 45.8 |

¹Sipomer ® Iboma from Solvay
²Styrene from Millipore Sigma
³2-ethylhexyl acrylate from Dow
⁴t-dodecyl mercaptan from Arkema
⁵Sipomer ® PAM-200 is a phosphoalkyl (meth)acrylate monomer from Solvay
⁶2-hydroxyethyl acrylate from BASF
⁷Hydroxyl-functional methacrylate monomer from Dow
⁸Luperox 575 from Arkema

### Preparation of Electrocoat A:

Electrocoat A, a cationic amine functional epoxy/isocyanate crosslinked electrocoat highly filled with a plate-like pigment was prepared. Components 1-4, listed in Table 3 below, were combined in a stainless-steel beaker and mixed under high sheer (2500 RPM using a 1.5-inch Cowles blade powered by a Fawcett air motor Model 103A) for 5 minutes starting at 40° C. The temperature was raised above 60° C. and the mixture was held with the above mixing for one hour after which the degree of the dispersion was determined by a Hegman gauge. The dispersion was determined to be adequately dispersed when a minimal reading of 5 was achieved.

For the dispersion step, a mixture of Components 5 and 6 were added to the mixture. A temperature of less than 60° C. was established and the dispersion was mixed with a high-lift blade at 1500 RPM for one hour. After dispersing, the dispersion was allowed to cool to ambient temperatures and Component 7 was added and mixed for one hour to bring the final solids of this dispersed paste to 40% on weight. Component 8 was then added into the dispersed formulation and allowed to mix under ambient temperatures for one hour to complete the feed at high solids. To generate Electrocoat A, the high solids feed was further diluted with Component 9 to 25% solids by weight.

TABLE 3

| | | Parts-by-weight |
|---|---|---|
| No. | Component | (grams) |
| 1 | ASP200 clay¹ | 457.9 |
| 2 | Amino functional epoxy /blocked | 837 |
| | isocyanate crosslinker binder (87.9% | |
| | solids) | |
| 3 | Phosphated acrylic polyol² | 30.07 |
| 4 | Phosphoric acid | 6.05 |
| 5 | Deionized water | 83.4 |
| 6 | Neutralizing Acid | 10.2 |
| 7 | Deionized water | 765.2 |
| 8 | Deionized water | 801 |
| 9 | Tin catalyst paste | 28.7 |
| 10 | Deionized water | 1780 |

¹ ASP200 clay available from BASF
² See Phosphated acrylic polyol above

### Preparation of Electrocoat B

Electrocoat B, a commercially available cationic electrodepositable coating composition with a 0.15 P:B, was prepared according to manufacturer's instructions.

### Examples 1-4

Panels for Examples 1-4 were prepared using Cold rolled steel (CRS) and Aluminum alloy 6111 (AA6111), both supplied from ACT Test Panels (Hillsdale, MI).

Panels were treated using either Treatment Method A, B, C, or D outlined in Tables 4, 5, 6, and 7, respectively.

For panels treated according to Treatment Method A, panels were spray cleaned for 120 seconds at 10-15 psi in the cleaner (120° F.) using Vee-jet nozzles and rinsed with deionized water by immersing in a deionized water bath (75° F.) for 30 seconds followed by a deionized water spray rinse using a Melnor Rear-Trigger 7-Pattern nozzle set to shower mode (available from Home Depot). Panels were then immersed in pretreatment for 120 seconds (80° F.), rinsed by a deionized water spray rinse using the Melnor Rear-Trigger 7-Pattern nozzle set to shower mode (75° F.) for 30 seconds, and dried with hot air (140° F.) for 120 seconds using the Hi-Velocity handheld blow-dryer.

For panels treated according to Treatment Method B, panels were spray cleaned for 120 seconds at 10-15 psi in the cleaner (120° F.) using Vee-jet nozzles and rinsed by a deionized water spray rinse using the Melnor Rear-Trigger 7-Pattern nozzle set to shower mode (75° F.) for 30 seconds, and dried with hot air (140° F.) for 120 seconds using a Hi-Velocity handheld blow-dryer made by Oster@(model number 078302-300-000) on high-setting.

For panels treated according to Treatment Method C, panels were immerse cleaned for 120 seconds (120° F.), rinsed by a deionized water spray rinse using the using the Melnor Rear-Trigger 7-Pattern nozzle set to shower mode (75° F.) for 30 seconds, and dried with hot air (140° F.) for 120 seconds using the Hi-Velocity handheld blow-dryer.

For panels treated according to Treatment Method D, panels were sprayed cleaned for 120 seconds at 10-15 psi in the pre-spray (120° F.) using Vee-jet nozzles. Panels were then immersed in an additional cleaner for 120 seconds (120° F.), rinsed by a deionized water spray rinse using the Melnor Rear-Trigger 7-Pattern nozzle set to shower mode (75° F.) for 30 seconds, and dried with hot air (140° F.) for 120 seconds using the Hi-Velocity handheld blow-dryer.

TABLE 4
Treatment Method A

| | |
|---|---|
| Step 1A | Cleaner (120 seconds, 120° F., spray application) |
| Step 2A | Deionized water rinse (30 seconds, 75° F., immersion |
| | application) |
| Step 3A | Deionized water rinse (30 seconds, 75° F., spray application) |
| Step 4A | Pretreatment (120-240 seconds, 80° F., immersion application) |
| Step 5A | Deionized water rinse (30 seconds, 75° F., spray application) |
| Step 6A | Hot Air Dry (120 seconds, 140° F.) |

TABLE 5
Treatment Method B

| | |
|---|---|
| Step 1B | Cleaner (120 seconds, 120° F., spray application) |
| Step 2B | Deionized water rinse (30 seconds, 75° F., spray application) |
| Step 3B | Hot Air Dry (120 seconds, 140° F.) |

TABLE 6
Treatment Method C

| | |
|---|---|
| Step 1C | Cleaner (120 seconds, 120° F., immersion application) |
| Step 2C | Deionized water rinse (30 seconds, 75° F., spray application) |
| Step 3C | Hot Air Dry (120 seconds, 140° F.) |

TABLE 7
Treatment Method D

| | |
|---|---|
| Step 1D | Pre-spray (60 seconds, 120° F., spray application) |
| Step 2D | Cleaner (120 seconds, 120° F., immersion application) |
| Step 3D | Deionized water rinse (30 seconds, 75° F., spray application) |
| Step 4D | Hot Air Dry (120 seconds, 140° F.) |

Following completion of Treatment Method A, B, C, or D, panels were coated with either Electrocoat A or Electrocoat B (a cationic electrocoat with 0.15 P:B).

Each test panel was submerged in the electrocoat and electrodeposition was carried out using a rectifier (Xantrax Model XFR600-2, Elkhart, Indiana, or Sorensen XZG 300-5.6, Ameteck, Berwyn, Pennsylvania) which was DC-power supplied. Exact coating conditions and film builds for each paint are found in Table 8. After the panels were electrocoated, each panel was rinsed with deionized water and baked at 177° C. in an electric oven (Despatch Model LFD-1-42).

TABLE 8

| Condition | EA | EB |
|---|---|---|
| Film build (mil) | 1.0 | 0.75 |
| Voltage (V) | 250 | 200 |
| Current (Amps) | 0.5 | 0.5 |
| Time (minutes) | 2 | 2 |
| Bake time (minutes) | 30 | 25 |

Electrocoated panels were vertically scribed on one side of the panel down to the metal substrate. For corrosion performance evaluation, panels were placed in CASS (Copper Accelerated Acetic Acid Salt Spray) testing for a minimum of 20 days or GMW14872 for a minimum of 30 cycles (i.e., 30 days). At the end of the test, the panels were rated by measuring the paint loss from the scribe (creep) and the maximum creepage (both sides) calculated in millimeters for each panel. After the exposure, corroded panels were dried under ambient conditions. The loose coating around the scribe was removed by applying a scotch filament tape (3M Industries Adhesives and Tapes Divisions, St. Paul, MN) and pulling it off. The width of exposed metal region along the scribe was then recorded for 5 to 12 locations and averaged to assess the corrosion performance of the panel. As used herein, scribe creep refers to the area of paint loss around the scribe either through corrosion or disbondment (e.g., affected paint to affected paint). Panels for each condition were run in duplicate and results averaged.

As described below, the non-electrocoated panels were analyzed for deposition of zirconium using hand-held X-ray fluorescence (XRF) measured using X-Met 8000, Oxford Instruments; operating parameters for zirconium and copper: 120 second timed assay, 40 Kv, 9 pA, Ka, T(p)=1.1 ps (reported as XRF peak area Zr net counts). Peak area was calculated by adding the XRF counts in the region of interest (ROI) or peak for the respective element, and then subtracting the counts from an untreated control panel.

### Example 1

CRS and AA6111 panels were treated with different treatment baths and treatment methods. Panels were then electrocoated with Electrocoat B according to the parameters described above. Panels were scribed and subjected to corrosion testing as specified in Table 9.

TABLE 9

| | | CRS Cyclic corrosion | AA6111 CASS |
|---|---|---|---|
| Treatment | Treatment | testing scribe creep | scribe creep |
| Code | Method | (30 cycles, mm) | (20 cycles, mm) |
| C1 + PT1 | A | 2.16 | 4.29 |
| C1 | B | 14.73 | 8.36 |
| C-C1 | C | 2.76 | 1.93 |

Example 1 demonstrates that CRS and AA6111 substrates treated with C-C 1 had improved or comparable corrosion performance over substrates treated with C1+PT1 and substantially improved corrosion performance over substrates treated with C1 alone. Moreover, C-Cl treatment has good corrosion performance using Treatment Method C with fewer process steps than C1+PT1 treatment using Treatment Method A.

### Example 2

CRS and AA6111 panels were treated with different treatment baths and treatment methods. Panels were then electrocoated with Electrocoat A according to the parameters described above. Panels were scribed and subjected to corrosion testing as specified in Table 10.

TABLE 10

| | | CRS Cyclic corrosion | AA6111 CASS |
|---|---|---|---|
| Treatment | Treatment | testing scribe creep | scribe creep |
| Code | Method | (30 cycles, mm) | (20 cycles, mm) |
| C1 + PT1 | A | 2.50 | 0.96 |
| C1 | B | 7.42 | 4.52 |
| C-C2 | B | 1.74 | 1.71 |
| P-S + C-C1 | D | 3.09 | 2.33 |

Example 2 shows that substrates treated with C-C2 exhibited good corrosion performance on CRS and AA6111 compared to a substrate treated with C1+PT1, and better corTosion performance than substrates treated with C1 and Electrocoat A on CRS and AA6111. Overall, substrates treated with C-C2 demonstrated good corrosion performance with fewer process steps than substrates treated with P-S+C-C1, while both substrates treated with C-C2 and P-S+C-Cl have even fewer process steps than substrates treated with Cl+PT1.

### Example 3

CRS and AA6111 panels were treated with different treatment baths and treatment methods and coated with different electrocoats. Panels were scribed and subjected to corrosion testing as specified in Table 11.

TABLE 11

| | | | CRS Cyclic | |
|---|---|---|---|---|
| | | | corrosion | AA6111 |
| | | | testing | CASS |
| | | | scribe | scribe |
| Treatment | Treatment | | creep (30 | creep (20 |
| Code | Method | Electrocoat | cycles, mm) | cycles, mm) |
| C1 + PT1 | A | EB | 2.16 | 4.29 |
| C1 | B | EB | 14.73 | 8.36 |
| C1 | B | EA | 7.42 | 4.52 |
| C-C 2 | B | EA | 1.74 | 1.71 |

Example 3 demonstrates that a substrate treated with C-C2 and Electrocoat A had improved corrosion performance on CRS and AA6111 compared to a substrate treated with C1+PT1 and Electrocoat B. A substrate treated with C-C2 and Electrocoat A had much better corrosion performance than a substrate treated with C1 and either Electrocoat A or Electrocoat B on CRS and AA6111. Thus, treating a substrate with C-C2 resulted in good corrosion performance with fewer process steps than treating a substrate with C1+PT1.

### Example 4

CRS panels were treated with different treatment baths and treatment methods and exposed to 25 mL of 6 N hydrochloric acid for 5 minutes to dissolve the pretreatment layer. Each etchant solution was submitted for ICP-OES and the concentrations of Cu and Zr were measured. These were converted into a coating weight (milligrams per square meter) for each condition. Additionally, CRS panels treated with different treatment baths and treatment methods were analyzed using hand-held XRF using the same parameters set forth above. The results are summarized in Table 12.

TABLE 12

| | | ICP Coating Weights | | XRF Peak Area | |
|---|---|---|---|---|---|
| Treatment | Treatment | Zr | Cu | Zr (net | Cu (net |
| Code | Method | (mg/m²) | (mg/m²) | counts) | counts) |
| C1 + PT1 | A | 47.6 | 27.4 | 5818 | 3178 |
| C-C1 | C | 6.2 | 22.2 | 1110 | 4500 |
| C-C2 | B | 3.9 | 23.3 | 985 | 5129 |

Example 4 shows that C-C1 and C-C2 treatments result in much lower Zr ICP coating weights and Zr XRF deposition when compared to the comparative treatment, C1+PT1. All three treatments result in comparable Cu ICP coating weights, but slightly higher Cu XRF deposition. Substrates treated with C-C1 and C-C2 exhibited lower Zr ICP coating weight and Zr XRF deposition than substrates treated with C1+PT1, while demonstrating improved or comparable corrosion performance, as shown in Examples 1 to 3, above. Thus, a substrate treated with the cleaner-coater compositions of the present disclosure provide comparable or improved corrosion performance with fewer steps and lower Zr deposition compared to a substrate treated with a cleaning composition and pretreatment composition.

1-23. (canceled)

24. A cleaner-coater composition comprising:
a Group IVB metal in an amount of 50 ppm to 8,000 ppm based on total weight of the cleaner-coater composition;
an electropositive metal;
a cleaner-coater builder comprising a phosphonate; and
a cleaner-coater surfactant in an amount of 50 ppm to 20,000 ppm based on total weight of the cleaner-coater composition.

25. The cleaner-coater composition of claim 24, wherein the Group IVB metal comprises zirconium and/or titanium.

26. The cleaner-coater composition of claim 24, wherein a source of the Group IVB metal comprises hexafluorozirconic acid, hexafluorotitanic acid, and/or salts thereof.

27. The cleaner-coater composition of claim 24, wherein the electropositive metal comprises copper.

28. The cleaner-coater composition of claim 24, wherein the phosphonate comprises a diphosphonate.

29. The cleaner-coater composition of claim 28, wherein the diphosphonate comprises etidronic acid.

30. The cleaner-coater composition of claim 24, wherein the surfactant comprises a catiotic surfactant, an anionic surfactant, and/or an amphoteric surfactant.

31. The cleaner-coater composition of claim 24, comprising:
(a) the electropositive metal in an amount of 2 ppm to 200 ppm;
(b) the cleaner-coater surfactant in an amount of 100 ppm to 10,000 ppm; and/or
(c) the cleaner-coater builder in an amount of 10 ppm to 2,500 ppm, wherein the amounts are based on total weight of the cleaner-coater composition.

32. The cleaner-coater composition of claim 24, wherein the cleaner-coater composition has a pH of 1.0 to 6.0.

33. The cleaner-coater composition of claim 24, wherein the cleaner-coater composition is substantially free of phosphate and/or sodium nitrobenzene sulfonate.

34. The cleaner-coater composition of claim 24, further comprising:
(d) total fluoride in an amount of 60 ppm to 10,000 ppm; and/or
(e) free fluoride in an amount of 25 ppm to 750 ppm wherein the amounts are based on total weight of the cleaner-coater composition.

35. A substrate comprising a surface treated with the cleaner-coater composition of claim 24.

36. A system for treating a substrate comprising:
(a) the cleaner-coater composition of claim 24 for treating a surface of the substrate; and
(b) an electrodepositable coating composition for coating the surface of the substrate treated with the cleaner-coater composition.

37. The system of claim 36, wherein the electrodepositable coating composition comprises a curing agent and an electrodepositable binder comprising an ionic salt group-containing film-forming polymer.

38. The system of claim 37, wherein the electrodepositable coating composition further comprises a plate-like pigment present in a pigment-to-binder ratio of at least 0.4:1.

39. The system of claim 36, further comprising a pre-spray composition comprising a pre-spray builder and a pre-spray surfactant in an amount of 50 ppm to 20,000 ppm based on total weight of the pre-spray composition.

40. The system of claim 39, wherein the pre-spray composition comprises the pre-spray builder in an amount of 5 ppm to 5,000 ppm based on total weight of the pre-spray composition.

41. The system of claim 39, wherein the pre-spray composition has a pH of 1 to 8.5.

42. A substrate comprising a surface (a) treated with the cleaner-coater composition of the system of claim 36 and (b) coated with the electrodepositable coating composition of the system of claim 36.
